(19) United States
(12) Patent Application Publication
(10) Pub. No.: US 2024/0273593 A1
(43) Pub. Date: Aug. 15, 2024

(54) SYSTEM AND METHOD FOR PROVIDING CUSTOMIZED HEADWEAR BASED ON FACIAL IMAGES

(71) Applicant: ResMed Pty Ltd, Bella Vista, New South Wales (AU)

(72) Inventors: Aaron Samuel DAVIDSON, Bella Vista, New South Wales (AU); Ian Andrew Law, Bella Vista, New South Wales (AU); James SUNG, Bella Vista, New South Wales (AU); Garth Alan BERRIMAN, Bella Vista, New South Wales (AU); Michael Christopher HOGG, Bella Vista, New South Wales (AU)

(21) Appl. No.: 18/566,405

(22) PCT Filed: Jun. 4, 2022
(86) PCT No.: PCT/IB2022/055219

§ 371 Date: Dec. 1, 2023

Related U.S. Application Data
(60) Provisional application No. 63/197,167, filed on Jun. 4, 2021.

(51) Int. Cl. G06Q 30/0601; G06Q 50/04; G06V 10/75; G06V 20/20; G06V 40/16

(52) U.S. Cl. CPC G06Q 30/0621; G06Q 30/0643; G06Q 50/04; G06V 10/751; G06V 20/20; G06V 40/165; G06V 40/171; G06V 2201/12

(57) ABSTRACT

A system and method to collect collecting data for customizing a facial interfacing structure for a head-mounted display interface for virtual reality or augmented reality systems. Facial image data is correlated to a user such as by scanning the face of the user. Facial feature data related to the facial interfacing structure is determined from the facial image data. Dimensions of the facial interfacing structure are determined from the facial feature data. A design of a customized facial interfacing structure including the determined dimensions is stored to produce the customized facial interfacing structure.

### PRIORITY CLAIM

The present disclosure claims priority to and the benefit of U.S. Provisional Patent Application No. 63/197,167 filed Jun. 4, 2021. The contents of that application are hereby incorporated by reference in their entirety.

### TECHNICAL FIELD

The present disclosure relates generally to designing specialized headwear, and more specifically to a system to collect facial data for customization of a head mounted display for virtual reality or augmented reality systems.

### BACKGROUND

An immersive technology refers to technology that attempts to replicate or augment a physical environment through the means of a digital or virtual environment by creating a surrounding sensory feeling, thereby creating a sense of immersion. In particular, an immersive technology provides the user visual immersion, and creates virtual objects on an actual environment (e.g., augmented reality (AR)) and/or a virtual environment (e.g., virtual reality). The immersive technology may also provide immersion for at least one of the other five senses.

Virtual reality (VR) is a computer-generated three-dimensional image or environment that is presented to a user. In other words, the environment may be entirely virtual. Specifically, the user observes an electronic screen in order to observe virtual or computer generated images in a virtual environment or in an augmented reality environment. Since the created environment is entirely virtual for VR, the user may be blocked and/or obstructed from interacting with their physical environment (e.g., they may be unable to hear and/or see the physical objects in the physical environment that they are currently located).

The electronic screen may be supported in the user's line of sight (e.g., mounted to the user's head). While observing the electronic screen, visual feedback output by the electronic screen and observed by the user may produce a virtual environment intended to simulate an actual environment. For example, the user may be able to look around (e.g., 360°) by pivoting their head or their entire body, and interact with virtual objects observable by the user through the electronic screen. This may provide the user with an immersive experience where the virtual environment provides stimuli to at least one of the user's five senses, and replaces the corresponding stimuli of the physical environment while the user uses the VR device. Typically, the stimuli relates at least to the user's sense of sight (i.e., because they are viewing an electronic screen), but other senses may also be included. The electronic screens are typically mounted to the user's head so that they may be positioned in close proximity to the user's eyes, which allows the user to easily observe the virtual environment.

A VR/AR device may produce other forms of feedback in addition to, or aside from, visual feedback. For example, the VR/AR device may include and/or be connected to a speaker in order to provide auditory feedback. The VR/AR device may also include tactile feedback (e.g., in the form of haptic response), which may correspond to the visual and/or auditory feedback. This may create a more immersive virtual environment, because the user receives stimuli corresponding to more than one of the user's senses.

While using a VR/AR device, a user may wish to limit to block ambient stimulation. For example, the user may want to avoid seeing and/or hearing the ambient environment in order to better process stimuli from the VR/AR device in the virtual environment. Thus, VR/AR devices may limit and/or prevent the user's eyes from receiving ambient light. In some examples, this may be done by providing a seal against the user's face. In some examples, a shield may be disposed proximate to (e.g., in contact or close contact with) the user's face, but may not seal against the user's face. In either example, ambient light may not reach the user's eyes, so that the only light observable by the user is from the electronic screen.

In other examples, the VR/AR devices may limit and/or prevent the user's ears from hearing ambient noise. In some examples, this may be done by providing the user with headphones (e.g., noise cancelling headphones), which may output sounds from the VR/AR device and/or limit the user from hearing noises from their physical environment. In some examples, the VR/AR device may output sounds at a volume sufficient to limit the user from hearing ambient noise.

In any example, the user may not want to become overstimulated (e.g., by both their physical environment and the virtual environment). Therefore, blocking and/or limiting the ambient from stimulating the user assists the user in focusing on the virtual environment, without possible distractions from the ambient.

Generally, a single VR/AR device may include at least two different classifications. For example, the VR/AR device may be classified by its portability and by how the display unit is coupled to the rest of the interface. These classifications may be independent, so that classification in one group (e.g., the portability of the unit) does not predetermine classification into another group. There may also be additional categories to classify VR devices, which are not explicitly listed below.

In some forms, a VR/AR device may be used in conjunction with a separate device, like a computer or video game console. This type of VR/AR device may be fixed, since it cannot be used without the computer or video game console, and thus locations where it can be used are limited (e.g., by the location of the computer or video game console).

Since the VR/AR device can be used in conjunction with the computer or video game console, the VR/AR device may be connected to the computer or video game console. For example, an electrical cord may tether the two systems together. This may further “fix” the location of the VR/AR device, since the user wearing the VR device cannot move further from the computer or video game console than the length of the electrical cord. In other examples, the VR/AR device may be wirelessly connected (e.g., via Bluetooth, Wi-Fi, etc.), but may still be relatively fixed by the strength of the wireless signal.

The connection to the computer or video game console may provide control functions to the VR/AR device. The controls may be communicated (i.e., through a wired connector or wirelessly) in order to help operate the VR/AR device. In examples of a fixed unit VR/AR device, these controls may be necessary in order to operate the display screen, and the VR/AR device may not be operable without the connection to the computer or video game console.

In some forms, the computer or video game console may provide electrical power to the VR/AR device, so that the user does not need to support a battery on their head. This may make the VR/AR device more comfortable to wear, since the user does not need to support the weight of a battery.

The user may also receive outputs from the computer or video game console at least partially through the VR/AR device, as opposed to through a television or monitor, which may provide the user with a more immersive experience while using the computer or video game console (e.g., playing a video game). In other words, the display output of the VR/AR device may be substantially the same as the output from a computer monitor or television. Some controls and/or sensors necessary to output these images may be housed in the computer or video game console, which may further reduce the weight that the user is required to support on their body.

In some forms, movement sensors may be positioned remote from the VR/AR device, and connected to the computer or video game console. For example, at least one camera may face the user in order to track movements of the user's head. The processing of the data recorded by the camera(s) may be done by the computer or video game console, before being transmitted to the VR/AR device. While this may assist in weight reduction of the VR/AR device, it may also further limit where the VR/AR device can be used. In other words, the VR/AR device must be in the sight line of the camera(s).

In some forms, the VR/AR device may be a self-contained unit, which includes a power source and sensors, so that the VR/AR device does not need to be connected to a computer or video game console. This provides the user more freedom of use and movement. For example, the user is not limited to using the VR/AR device near a computer or video game console, and could use the VR/AR device outdoors, or in other environments that do not include computers or televisions.

Since the VR/AR device is not connected to a computer or video game console in use, the VR/AR device is required to support all necessary electronic components. This includes batteries, sensors, and processors. These components add weight to the VR/AR device, which the user must support on their body. Appropriate weight distribution may be needed so that this added weight does not increase discomfort to a user wearing the VR/AR device.

In some forms, the electrical components of the VR/AR device are contained in a single housing, which may be disposed directly in front of the user's face, in use. This configuration may be referred to as a “brick.” In this configuration, the center of gravity of the VR/AR device without the positioning and stabilizing structure is directly in front of the user's face. In order to oppose the moment created by the force of gravity, the positioning and stabilizing structure coupled to the brick configuration must provide a force directed into the user's face, for example created by tension in headgear straps. While the brick configuration may be beneficial for manufacturing (e.g., since all electrical components are in close proximity) and may allow interchangeability of positioning and stabilizing structures (e.g., because they include no electrical connections), the force necessary to maintain the position of the VR/AR device (e.g., tensile forces in headgear) may be uncomfortable to the user. Specifically, the VR/AR device may dig into the user's face, leading to irritation and markings on the user's skin. The combination of forces may feel like “clamping” as the user's head receives force from the display housing on their face and force from headgear on the back of their head. This may make a user less likely to wear the VR/AR device.

As VR and other mixed reality devices may be used in a manner involving vigorous movement of the user's head and/or their entire body (for example during gaming), there may be significant forces/moments tending to disrupt the position of the device on the user's head. Simply forcing the device more tightly against the user's head to tolerate large disruptive forces may not be acceptable as it may be uncomfortable for the user or become uncomfortable after only a short period of time.

In some forms, electrical components may be spaced apart throughout the VR/AR device, instead of entirely in front of the user's face. For example, some electrical components (e.g., the battery) may be disposed on the positioning and stabilizing structure, particularly on a posterior contacting portion. In this way, the weight of the battery (or other electrical components) may create a moment directed in the opposite direction from the moment created by the remainder of the VR/AR device (e.g., the display). Thus, it may be sufficient for the positioning and stabilizing structure to apply a lower clamping force, which in turn creates a lower force against the user's face (e.g., fewer marks on their skin). However, cleaning and/or replacing the positioning and stabilizing structure may be more difficult in some such existing devices because of the electrical connections.

In some forms, spacing the electrical components apart may involve positioning some of the electrical components separate from the rest of the VR/AR device. For example, a battery and/or a processor may be electrically connected, but carried separately from the rest of the VR/AR device. Unlike in the “fixed units” described above, the battery and/or processor may be portable, along with the remainder of the VR/AR device. For example, the battery and/or the processor may be carried on the user's belt or in the user's pocket. This may provide the benefit of reduced weight on the user's head, but would not provide a counteracting moment. The tensile force provided by the positioning and stabilizing structure may still be less than the “brick” configuration, since the total weight supported by the head is less.

A head-mounted display interface enables a user to have an immersive experience of a virtual environment and have broad application in fields such as communications, training, medical and surgical practice, engineering, and video gaming.

Different head-mounted display interfaces can each provide a different level of immersion. For example, some head-mounted display interfaces can provide the user with a total immersive experience. One example of a total immersive experience is virtual reality (VR). The head-mounted display interface can also provide partial immersion consistent with using an augmented reality (AR) device.

VR head-mounted display interfaces typically are provided as a system that includes a display unit which is arranged to be held in an operational position in front of a user's face. The display unit typically includes a housing containing a display and a user interface structure constructed and arranged to be in opposing relation with the user's face. The user interface structure may extend about the display and define, in conjunction with the housing, a viewing opening to the display. The user interfacing structure may engage with the face and include a cushion for user comfort and/or be light sealing to block ambient light from the display. The head-mounted display system further comprises a positioning and stabilizing structure that is disposed on the user's head to maintain the display unit in position.

Other head-mounted display interfaces can provide a less than total immersive experience. In other words, the user can experience elements of their physical environment, as well as a virtual environment. Examples of a less than total immersive experience are augmented reality (AR) and mixed reality (MR).

AR and/or MR head-mounted display interfaces are also typically provided as a system that includes a display unit which is arranged to be held in an operational position in front of a user's face. Likewise, the display unit typically includes a housing containing a display and a user interface structure constructed and arranged to be in opposing relation with the user's face. The head-mounted display system of the AR and/or MR head-mounted display is also similar to VR in that it further comprises a positioning and stabilizing structure that is disposed on the user's head to maintain the display unit in position. However, AR and/or MR head-mounted displays do not include a cushion that totally seals ambient light from the display, since these less than total immersive experience require an element of the physical environment. Instead, head-mounted displays in augmented and/or mixed allow the user to see the physical environment in combination with the virtual environment.

In any types of immersive technology, it is important that the head-mounted display interface is comfortable in order to allow the user to wear the head-mounted display for extended periods of time. Additionally, it is important that the display is able to provide changing images with changing position and/or orientation of the user's head in order to create an environment, whether partially or entirely virtual, that is similar to or replicates one that is entirely physical.

The head-mounted displays may include a user interfacing structure. Since the interfacing portion is in direct contact with the user's face, the shape and configuration of the interfacing portion can have a direct impact on the effectiveness and comfort of the display unit. Further the interfacing portion may provide stability in applications where the user must physically move around. A stable interfacing portion prevents overtightening of the display by a user for stability.

The design of a user interfacing structure presents a number of challenges. The face has a complex three-dimensional shape. The size and shape of noses and heads varies considerably between individuals. Since the head includes bone, cartilage and soft tissue, different regions of the face respond differently to mechanical forces.

One type of interfacing structure extends around the periphery of the display unit and is intended to seal against the user's face when force is applied to the user interface with the interfacing structure in confronting engagement with the user's face. The interfacing structure may include a pad made of a polyurethane (PU). With this type of interfacing structure, there may be gaps between the interfacing structure and the face, and additional force may be required to force the display unit against the face in order to achieve the desired contact.

The regions not engaged at all by the user interface may allow gaps to form between the facial interface and the user's face through which undesirable light pollution may ingress into the display unit (e.g., particularly when using virtual reality). The light pollution or “light leak” may decrease the efficacy and enjoyment of the overall immersive experience for the user. In addition, previous systems may be difficult to adjust to enable application for a wide variety of head sizes. Further still, the display unit and associated stabilizing structure may often be relatively heavy and may be difficult to clean which may thus further limit the comfort and usability of the system.

Another type of interfacing structure incorporates a flap seal of thin material positioned about a portion of the periphery of the display unit so as to provide a sealing action against the face of the user. Like the previous style of interfacing structure, if the match between the face and the interfacing structure is not good, additional force may be required to achieve a seal, or light may leak into the display unit in-use. Furthermore, if the shape of the interfacing structure does not match that of the user, it may crease or buckle in-use, giving rise to undesirable light penetration.

A user interface may be partly characterised according to the design intent of where the interfacing structure is to engage with the face in-use. Some interfacing structures may be limited to engaging with regions of the user's face that protrude beyond the arc of curvature of the face engaging surface of the interfacing structure. These regions may typically include the user's forehead and cheek bones. This may result in user discomfort at localised stress points. Other facial regions may not be engaged at all by the interfacing structure or may only be engaged in a negligible manner that may thus be insufficient to increase the translation distance of the clamping pressure. These regions may typically include the sides of the user's face, or the region adjacent and surrounding the user's nose. To the extent to which there is a mismatch between the shape of the users' face and the interfacing structure, it is advantageous for the interfacing structure or a related component to be adaptable in order for an appropriate contact or other relationship to form.

To hold the display unit in its correct operational position, the head-mounted display system further comprises a positioning and stabilizing structure that is disposed on the user's head. These structures may be responsible for providing forces to counter gravitational forces and other accelerations due to head movement of the head-mounted display and/or interfacing structure. In the past these structures have been formed from expandable rigid structures that are typically applied to the head under tension to maintain the display unit in its operational position. Such systems have been prone to exert a clamping pressure on the user's face which can result in user discomfort at localised stress points. Also, previous systems may be difficult to adjust to allow wide application head sizes. Further, the display unit and associated stabilizing structure are often heavy, difficult to clean which further limit the comfort and usability of the system.

Certain other head mounted display systems may be functionally unsuitable for the present field. For example, positioning and stabilizing structures designed for ornamental and visual aesthetics may not have the structural capabilities to maintain a suitable pressure around the face. For example, an excess of clamping pressure may cause discomfort to the user, or alternatively, insufficient clamping pressure on the users' face may not effectively seal the display from ambient light.

As a consequence of these challenges, some head mounted displays suffer from being one or more of obtrusive, aesthetically undesirable, costly, poorly fitting, difficult to use, and uncomfortable especially when worn for long periods of time or when a user is unfamiliar with a system. Wrongly sized positioning and stabilizing structures can give rise reduced comfort and in turn, shortened periods of use.

There is a need for a system that allows for the provision of a head mounted display for immersive applications, such as VR and AR, based on individual features of a user. There is another need for a system that collects facial feature data and modifies dimensions of a head mounted display for optimal fit to a user.

### SUMMARY

One disclosed example is a method of collecting data for customizing a facial interfacing structure for a head-mounted display interface. Facial image data is correlated to a user. Facial feature data is determined from the facial image data. Dimensions of the facial interfacing structure are determined from the facial feature data. A design of a customized facial interfacing structure including the determined dimensions is stored.

A further implementation of the example method is where the head-mounted display interface is part of a virtual reality system, an augmented reality system, or a modified reality system. Another implementation is where the facial image data is taken from a mobile device with an application to capture the facial image of the user. Another implementation is where the example method further includes displaying a feature selection interface for user input and the design includes the user input. Another implementation is where the user input is a selection of a customized head-mounted display interface including the customized facial interfacing structure. Another implementation is where the user input is one of a color, an identifier, a pattern, or a style of the facial interfacing structure. Another implementation is where the user input is a cushioning material for the facial interfacing structure. Another implementation is where the determination of the dimensions of the feature selection interface includes evaluating demographic data, ethnicity, and use of headwear by the user. Another implementation is where the facial feature data includes forehead curvature, head width, cheek bones, Rhinion profile, and nose width. Another implementation is where the determining facial feature data includes detecting one or more facial features of the user in the facial image data and a predetermined reference feature having a known dimension in the facial image data. Another implementation is where the determining facial feature data includes processing image pixel data from the facial image data to measure an aspect of the one or more facial features detected based on the predetermined reference feature. Another implementation is where 2D pixel coordinates from the pixel data are converted to 3D coordinates for 3D analysis of the distances. Another implementation is where the predetermined reference feature is an iris of the user. Another implementation is where the determining dimensions of the facial interfacing structure includes selecting a facial interface size from a group of standard facial interface sizes based on a comparison between the facial feature data and a data record relating sizing information of the group of standard facial interface sizes and the facial feature data. Another implementation is where the determining facial feature data includes applying an anthropometric correction factor. Another implementation is where the determining dimension of the facial interfacing structure includes determining points of engagement of the face of the user with the facial interfacing structure. Another implementation is where the dimensions of the facial interfacing structure are determined to minimize light leak of the facial interfacing structure when worn by the user. Another implementation is where the dimensions of the facial interfacing structure are determined to minimize gaps between the face of the user and of the facial interfacing structure. Another implementation is where the example method includes training a machine learning model to output a correlation between at least one facial feature and dimensions of the facial interfacing structure. The determining dimensions of the facial interfacing structure includes the output of the trained machine learning model. Another implementation is where the training includes providing the machine learning model a training data set based on the outputs of favorable operational results of facial interfacing structures, and user facial features inputs and subjective data collected from users.

Another disclosed example is a computer program product comprising instructions which, when executed by a computer, cause the computer to carry out the above methods. Another implementation of the computer program product is where the computer program product is a non-transitory computer readable medium.

Another disclosed example is a system including a control system comprising one or more processors and a memory having stored thereon machine readable instructions. The control system is coupled to the memory, and the above described methods are implemented when the machine executable instructions in the memory are executed by at least one of the one or more processors of the control system.

Another disclosed example is a computer program product comprising instructions which, when executed by a computer, cause the computer to carry out the above methods. Another implementation of the computer program product is where the computer program product is a non-transitory computer readable medium.

Another disclosed example is a method of manufacturing a facial interfacing structure for a head-mounted display interface. Facial image data is correlated to a user. Facial feature data is determined from the facial image data. Dimensions of the facial interfacing structure are determined from the facial feature data. A design of a customized facial interfacing structure including the determined dimensions is stored. The customized facial interface structure is fabricated by a manufacturing system based on the stored design.

A further implementation of the example method is where the manufacturing system includes at least one of a tooling machine, a molding machine, or a 3D printer. Another implementation is where the head-mounted display interface is part of a virtual reality system, an augmented reality system, or a modified reality system. Another implementation is where the facial image data is taken from a mobile device with an application to capture the facial image of the user. Another implementation is where the example method includes displaying a feature selection interface and collecting preference data from the user of a color, an identifier, a pattern, or a style of the customized facial interface structure. The fabricating includes incorporating the preference data from the user. Another implementation is where the example method includes displaying a feature selection interface and collecting preference data from the user of cushioning material for the customized facial interface structure. The fabricating includes incorporating the cushioning material preferred by the user.

Another disclosed example is a manufacturing system for producing a customized facial interfacing structure for a head-mounted display interface. The system includes a storage device storing facial image data of the user. Aa controller is coupled to the storage device. The controller determines facial feature data of the user from the facial image data and determines dimensions of the facial interfacing structure from the facial feature data. The controller stores a design of the customized facial interfacing structure including the determined dimensions in the storage device. A manufacturing device is coupled to the controller and fabricates the customized facial interface based on the stored design.

Another disclosed example is a method of collecting data for customizing a facial interfacing structure for a head-mounted display interface. Facial image data stored in a storage device is correlated to a user via a processor. Facial feature data from the facial image data is determined via the processor executing a facial analysis application. Dimensions of the facial interfacing structure are determined from the facial feature data via the processor. A design of a customized facial interfacing structure including the determined dimensions is stored in the storage device.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 shows a user wearing a head-mounted display customized for the user's facial features;

FIG. 2A is a front perspective view of an example head-mounted display interface;

FIG. 2B shows a rear perspective view of the head-mounted display of FIG. 2A;

FIG. 2C shows a perspective view of a positioning and stabilizing structure used with the head-mounted display of FIG. 2A;

FIG. 2D shows a front view of a user's face, illustrating a location of an interfacing structure, in use.

FIG. 3A is a front view and side views of a face with several features of surface anatomy;

FIG. 3B-1 is a front view of a face with several dimensions of a face and nose identified;

FIG. 3B-2 is a side view of a face with several dimensions of a face and nose identified;

FIG. 3B-3 is a base view of a face with several dimensions of a face and nose identified;

FIG. 3C is a side view and front of a head with a forehead height dimension identified;

FIG. 3D is a front view of a head with a forehead height dimension identified;

FIG. 3E is a side view and front of a head with an interpupillary distance dimension identified;

FIG. 3F is a side view and front of a head with a nasal root breadth dimension identified;

FIG. 3G is a side view and front of a head with a top of ear to top of head distance dimension identified;

FIG. 3H is a side view and front of a head with a brow height dimension identified;

FIG. 3I is a side view and front of a head with a bitragion coronial arc dimension identified;

FIG. 4 is a diagram of an example system for collecting facial data for providing a customized head mounted display interface which includes a computing device;

FIG. 5 is a diagram of the components of a computing device used to capture facial data;

FIG. 6A is a screen image of an interface for collection of user name data for an individualized head mounted display;

FIG. 6B is a screen image of an interface for collection of user demographic data for an individualized head mounted display;

FIG. 6C is a screen image of an interface for collection of user demographic data for an individualized head mounted display;

FIG. 6D is a screen image of an interface for collection of data for use of an individualized head mounted display;

FIG. 7A is a screen image of an interface to allow the selection of the color of an individualized head mounted display;

FIG. 7B is a screen image of an interface to allow the application of an identifier of an individualized head mounted display;

FIG. 7C is a screen image of an interface to allow the selection of the pattern of an individualized head mounted display;

FIG. 7D is a screen image of an interface to allow the selection of the style of an individualized head mounted display;

FIG. 7E is a screen image of an interface to allow the selection of the color of an individualized head mounted display;

FIG. 7F is a screen image of an interface to allow the selection of the color of a strap for an individualized head mounted display;

FIG. 8A is a screen image of an interface that instructs a user to capture images of their face;

FIG. 8B is a screen image of an interface that instructs a user to align their face for the image capture;

FIG. 8C is a screen image of an interface that captures a front facial image;

FIG. 8D is a screen image of an interface that captures one side facial image;

FIG. 8E is a screen image of an interface that captures another side facial image;

FIG. 8F is a screen image of an interface displaying a 3D head model determined from the captured facial images;

FIG. 9 is a flow diagram of the process of collection of data from a user for determining characteristics for an individualized head mounted display; and

FIG. 10 is a diagram of a manufacturing system to produce customized individualized head mounted display interfaces based on collected data.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure relates to a system and method for customized sizing of an Augmented Reality (AR)/Virtual Reality (VR)/Mixed Reality (MR) facial interface (also referred to as “facial interface” hereinafter) without the assistance of a trained individual or others. Another aspect of one form of the present technology is the automatic measurement of a subject's (e.g., a user's) facial features based on data collected from the user. Another aspect of one form of the present technology is the automatic determination of a facial interface size based on a comparison between data collected from a user to a corresponding data record.

Another aspect of one form of the present technology is a mobile application that conveniently determines an appropriate facial interface size for a particular user based on a single (frontal) or multiple two-dimensional images. Another aspect of one form of the present technology is a mobile application that conveniently determines an appropriate facial interface size for a particular user based on a three-dimensional image.

The method may include receiving image data captured by an image sensor. The captured image data may contain one or more facial features of an intended user of the facial interface in association with a predetermined reference feature having a known dimension such as an eye iris. The method may include detecting one or more facial features of the user in the captured image data. The method may include detecting the predetermined reference feature in the captured image data. The method may include processing image pixel data of the image to measure an aspect of the one or more facial features detected in the image based on the predetermined reference feature. The method may include selecting a facial interface size from a group of standard facial interface sizes based on a comparison between the measured aspect of the one or more facial features and a data record relating sizing information of the group of standard facial interface sizes and the measured aspect of the one or more facial features.

Some versions of the present technology include a system(s) for automatically designing a facial interface complementary to a particular user's facial features. The system(s) may include a mobile computing device. The mobile computing device may be configured to communicate with one or more servers over a network. The mobile computing device may be configured to receive captured image data of facial features. The captured image data may contain one or more facial features of a user in association with a predetermined reference feature having a known dimension. The image data may be captured with an image sensor. The mobile computing device may be configured to detect one or more facial features of the user in the captured image data. The mobile computing device may be configured to detect the predetermined reference feature in the captured image data. The mobile computing device may be configured to process image pixel data of the image to measure an aspect of the one or more facial features detected in the image based on the predetermined reference feature. The mobile computing device may be configured to customize a facial interface display based on a measured aspect of the one or more facial features.

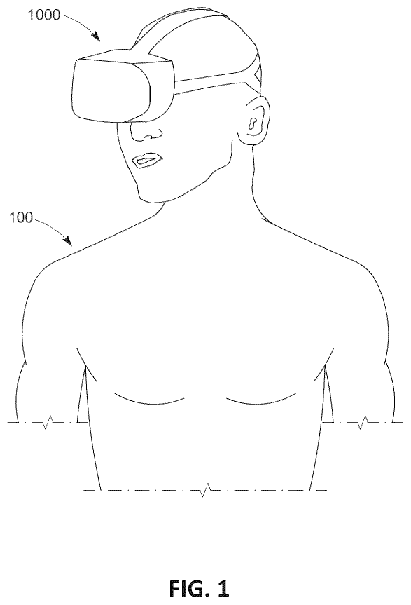

FIG. 1 shows a system including a user 100 wearing a head-mounted display interface system 1000, in the form of a face-mounted, virtual reality (VR) headset, displaying various images to the user 100. The user is standing while wearing the head-mounted display interface system 1000. The headset of the interface system 1000 may also be used for augmented reality (AR) or mixed reality (MR) applications that are customized for the user.

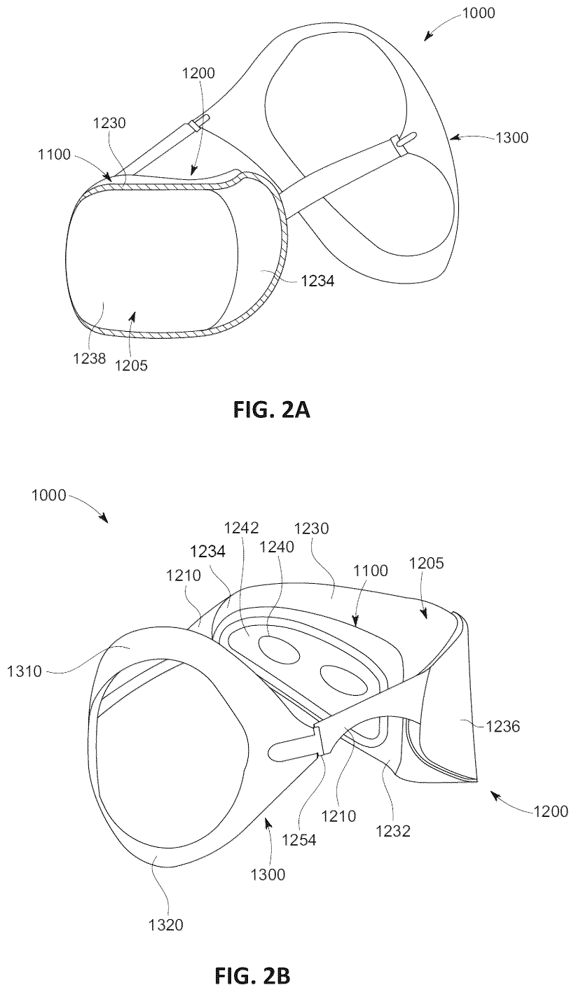

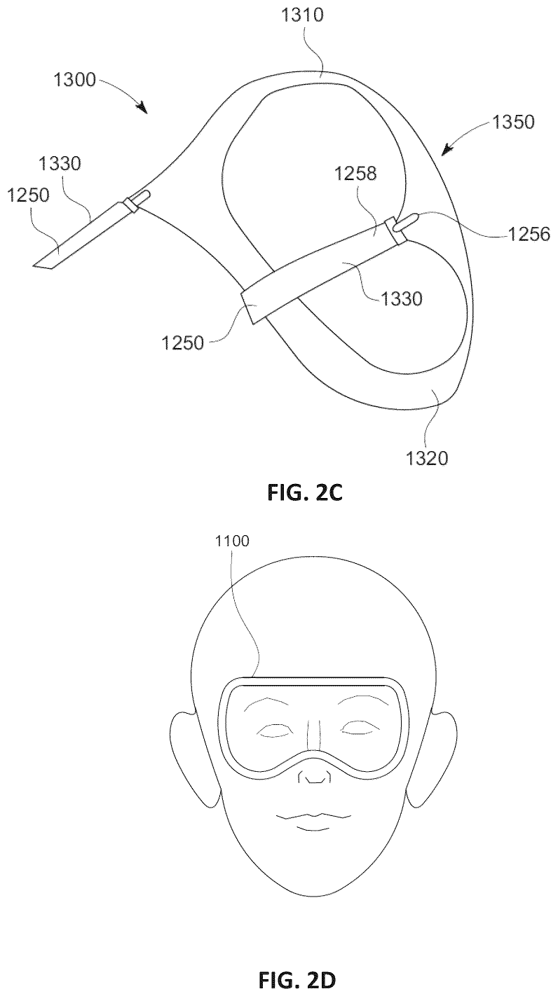

FIG. 2A shows a front perspective view of the head-mounted display interface system 1000 and FIG. 2B shows a rear perspective view of the head-mounted display interface system 1000. The head-mounted display system 1000 in accordance with one aspect of the present technology comprises the following functional aspects: a facial interfacing structure 1100, a head-mounted display unit 1200, and a positioning and stabilizing structure 1300. In some forms, a functional aspect may provide one or more physical components. In some forms, one or more physical components may provide one or more functional aspects. The head-mounted display unit 1200 may comprise a display. In use, the head-mounted display unit 1200 is arranged to be positioned proximate and anterior to the user's eyes, so as to allow the user to view the display.

In other aspects, the head-mounted display system 1000 may also include a display unit housing 1205, an optical lens 1240, a controller 1270, a speaker 1272, a power source 1274, and/or a control system 1276. In some examples, these may be integral pieces of the head-mounted display system 1000, while in other examples, these may be modular and incorporated into the head-mounted display system 1000 as desired by the user.

The head-mounted display unit 1200 may include a structure for providing an observable output to a user. Specifically, the head-mounted display unit 1200 is arranged to be held (e.g., manually, by a positioning and stabilizing structure, etc.) in an operational position in front of a user's face.

In some examples, the head-mounted display unit 1200 may include a display screen 1220, a display unit housing 1205, a facial interfacing structure 1100, and/or an optical lens 1240. These components may be permanently assembled in a single head-mounted display unit 1200, or they may be separable and selectively connected by the user to form the head-mounted display unit 1200. Additionally, the display screen 1220, the display unit housing 1205, the interfacing structure 1100, and/or the optical lens 1240 may be included in the head-mounted display system 1000, but may not be part of the head-mounted display unit 1200.

Some forms of the head-mounted display unit 1200 include a display, for example a display screen—not shown in FIG. 2B, but provided within the display housing 1205. The display screen may include electrical components that provide an observable output to the user. In one form of the present technology, a display screen provides an optical output observable by the user. The optical output allows the user to observe a virtual environment and/or a virtual object. The display screen may be positioned proximate to the user's eyes, in order to allow the user to view the display screen. For example, the display screen may be positioned anterior to the user's eyes. The display screen can output computer generated images and/or a virtual environment. In some forms, the display screen is an electronic display. The display screen may be a liquid crystal display (LCD), or a light emitting diode (LED) screen. In certain forms, the display screen may include a backlight, which may assist in illuminating the display screen. This may be particularly beneficial when the display screen is viewed in a dark environment. In some forms, the display screen may extend wider a distance between the user's pupils. The display screen may also be wider than a distance between the user's cheeks. In some forms, the display screen may display at least one image that is observable by the user. For example, the display screen may display images that change based on predetermined conditions (e.g., passage of time, movement of the user, input from the user, etc.). In certain forms, portions of the display screen may be visible to only one of the user's eyes. In other words, a portion of the display screen may be positioned proximate and anterior to only one of the user's eyes (e.g., the right eye), and is blocked from view from the other eye (e.g., the left eye). In one example, the display screen may be divided into two sides (e.g., a left side and a right side), and may display two images at a time (e.g., one image on either side). Each side of the display screen may display a similar image. In some examples, the images may be identical, while in other examples, the images may be slightly different. Together, the two images on the display screen may form a binocular display, which may provide the user with a more realistic VR experience. In other words, the user's brain may process the two images from the display screen 1220 together as a single image. Providing two (e.g., un-identical) images may allow the user to view virtual objects on their periphery, and expand their field of view in the virtual environment. In certain forms, the display screen may be positioned in order to be visible by both of the user's eyes. The display screen may output a single image at a time, which is viewable by both eyes. This may simplify the processing as compared to the multi-image display screen.

In some forms of the present technology as shown in FIGS. 2A-2B, a display unit housing 1205 provides a support structure for the display screen, in order to maintain a position of at least some of the components of the display screen relative to one another, and may additionally protect the display screen and/or other components of the head-mounted display unit 1200. The display unit housing 1205 may be constructed from a material suitable to provide protection from impact forces to the display screen. The display unit housing 1205 may also contact the user's face, and may be constructed from a biocompatible material suitable for limiting irritation to the user.

A display unit housing 1205 in accordance with some forms of the present technology may be constructed from a hard, rigid or semi-rigid material, such as plastic. In certain forms, the rigid or semi-rigid material may be at least partially covered with a soft and/or flexible material (e.g., a textile, silicone, etc.). This may improve biocompatibility and/or user comfort because the at least a portion of the display unit housing 1205 that the user engages (e.g., grabs with their hands) includes the soft and/or flexible material. A display unit housing 1205 in accordance with other forms of the present technology may be constructed from a soft, flexible, resilient material, such as silicone rubber. In some forms, the display unit housing 1205 may have a substantially rectangular or substantially elliptical profile. The display unit housing 1205 may have a three-dimensional shape with the substantially rectangular or substantially elliptical profile.

In certain forms, the display unit housing 1205 may include a superior face 1230, an inferior face 1232, a lateral left face 1234, a lateral right face 1236, and an anterior face 1238. The display screen 1220 may be held within the faces in use. In certain forms, the superior face 1230 and the inferior face 1232 may have substantially the same shape. In one form, the superior face 1230 and the inferior face 1232 may be substantially flat, and extend along parallel planes (e.g., substantially parallel to the Frankfort horizontal in use). In certain forms, the lateral left face 1234 and the lateral right face 1236 may have substantially the same shape. In one form, the lateral left face 1234 and the lateral right face 1236 may be curved and/or rounded between the superior and inferior faces 1230, 1232. The rounded and/or curved faces 1234, 1236 may be more comfortable for a user to grab and hold while donning and/or doffing the head-mounted display system 1000.

In certain forms, the anterior face 1238 may extend between the superior and inferior faces 1230, 1232. The anterior face 1238 may form the anterior most portion of the head-mounted display system 1000. In one form, the anterior face 1238 may be a substantially planar surface, and may be substantially parallel to the coronal plane, while the head-mounted display system 1000 is worn by the user. In one form, the anterior face 1238 may not have a corresponding opposite face (e.g., a posterior face) with substantially the same shape as the anterior face 1238. The posterior portion of the display unit housing 1205 may be at least partially open (e.g., recessed in the anterior direction) in order to receive the user's face.

In some forms, the display screen is permanently integrated into the head-mounted display system 1000. The display screen may be a device usable only as a part of the head-mounted display system 1000. In some forms, the display unit housing 1205 may enclose the display screen, which may protect the display screen and/or limit user interference (e.g., moving and/or breaking) with the components of the display screen.

In certain forms, the display screen may be substantially sealed within the display unit housing 1205, in order to limit the collection of dirt or other debris on the surface of the display screen, which could negatively affect the user's ability to view an image output by the display screen. The user may not be required to break the seal and access the display screen, since the display screen is not removable from the display unit housing 1205. In some forms, the display screen is removably integrated into the head-mounted display system 1000. The display screen may be a device usable independently of the head-mounted display system 1000 as a whole. For example, the display screen may be provided on a smart phone, or other portable electronic device.

In some forms, the display unit housing 1205 may include a compartment. A portion of the display screen may be removably receivable within the compartment. For example, the user may removably position the display screen in the compartment. This may be useful if the display screen performs additional functions outside of the head-mounted display unit 1200 (e.g., is a portable electronic device like a cell phone). Additionally, removing the display screen from the display unit housing 1205 may assist the user in cleaning and/or replacing the display screen. Certain forms of the display housing include an opening to the compartment, allowing the user to more easily insert and remove the display screen from the compartment. The display screen may be retained within the compartment via a frictional engagement. In certain forms, a cover may selectively cover the compartment, and may provide additional protection and/or security to the display screen 1220 while positioned within the compartment. In certain forms, the compartment may open on the superior face. The display screen may be inserted into the compartment in a substantially vertical direction while the display interface 3000 is worn by the user.

As shown in FIGS. 2A-2B, some forms of the present technology include an interfacing structure 1100 is positioned and/or arranged in order to conform to a shape of a user's face, and may provide the user with added comfort while wearing and/or using the head-mounted display system 1000. In some forms, the interfacing structure 1100 is coupled to a surface of the display unit housing 1205. In some forms, the interfacing structure 1100 may extend at least partially around the display unit housing 1205, and may form a viewing opening. The viewing opening may at least partially receive the user's face in use. Specifically, the user's eyes may be received within the viewing opening formed by the interfacing structure 1100.

In some forms, the interfacing structure 1100 in accordance with the present technology may be constructed from a biocompatible material. In some forms, the interfacing structure 1100 in accordance with the present technology may be constructed from a soft, flexible, and/or resilient material. In certain forms, the interfacing structure 1100 in accordance with the present technology may be constructed from silicone rubber and/or foam. In some forms, the interfacing structure 1100 may contact sensitive regions of the user's face, which may be locations of discomfort. The material forming the interfacing structure 1100 may cushion these sensitive regions, and limit user discomfort while wearing the head-mounted display system 1000. In certain forms, these sensitive regions may include the user's forehead. Specifically, this may include the region of the user's head that is proximate to the frontal bone, like the Epicranius and/or the glabella. This region may be sensitive because there is limited natural cushioning from muscle and/or fat between the user's skin and the bone. Similarly, the ridge of the user's nose may also include little to no natural cushioning.

In some forms, the interfacing structure 1100 may comprise a single element. In some embodiments the interfacing structure 1100 may be designed for mass manufacture. For example, the interfacing structure 1100 may be designed to comfortably fit a wide range of different face shapes and sizes. In some forms, the interfacing structure 1100 may include different elements that overlay different regions of the user's face. The different portions of the interfacing structure 1100 may be constructed from different materials, and provide the user with different textures and/or cushioning at different regions.

Some forms of the head-mounted display system 1000 may include a light shield that may be constructed from an opaque material and can block ambient light from reaching the user's eyes. The light shield may be part of the interfacing structure 1100 or may be a separate element. In some examples the interfacing structure 1100 may form a light shield by shielding the user's eyes from ambient light, in addition to providing a comfortable contacting portion for contact between the head-mounted display 1200 and the user's face. In some examples a light shield may be formed from multiple components working together to block ambient light.

FIG. 2C shows a perspective view of a positioning and stabilizing structure used with the head-mounted display 1000. FIG. 2D shows a front view of a user's face, illustrating a location of an interfacing structure, in use. the interfacing structure 1100 acts as a seal-forming structure, and provides a target seal-forming region. The target seal-forming region is a region on the seal-forming structure where sealing may occur. The region where sealing actually occurs, the actual sealing surface, may change within a given session, from day to day, and from user to user, depending on a range of factors including but not limited to, where the display unit housing 1205 is placed on the face, tension in the positioning and stabilizing structure 1300, and/or the shape of a user's face. In one form the target seal-forming region is located on an outside surface of the interfacing structure 1100. In some forms, the light shield may form the seal-forming structure and seal against the user's face. In certain forms of the present technology, a system is provided to shape the interfacing structure 1100 to correspond to different sizes and/or shapes. For example, the interfacing structure 1100 may be tailored for a large sized head or a small sized head.

As shown in FIG. 2B, at least one lens 1240 may be disposed between the user's eyes and the display screen 1220. The user may view an image provided by the display screen 1220 through the lens 1240. The at least one lens 1240 may assist in spacing the display screen 1220 away from the user's face to limit eye strain. The at least one lens 1240 may also assist in better observing the image being displayed by the display screen 1220. In some forms, the lenses 1240 are Fresnel lenses. In some forms, the lens 1240 may have a substantially frustoconical shape. A wider end of the lens 1240 may be disposed proximate to the display screen 1220, and a narrower end of the lens 1240 may be disposed proximate to the user's eyes, in use. In some forms, the lens 1240 may have a substantially cylindrical shape, and may have substantially the same width proximate to the display screen 1220, and proximate to the user's eyes, in use. In some forms, the at least one lens 1240 may also magnify the image of the display screen 1220, in order to assist the user in viewing the image.

In some forms, the head-mounted display system 1000 includes two lenses 1240 (e.g., binocular display), one for each of the user's eyes. In other words, each of the user's eyes may look through a separate lens positioned anterior to the respective pupil. Each of the lenses 1240 may be identical, although in some examples, one lens 1240 may be different than the other lens 1240 (e.g., have a different magnification). In certain forms, the display screen 1220 may output two images simultaneously. Each of the user's eyes may be able to see only one of the two images. The images may be displayed side-by-side on the display screen 1220. Each lens 1240 permits each eye to observe only the image proximate to the respective eye. The user may observe these two images together as a single image. In some forms, the posterior perimeter of each lens 1240 may be approximately the size of the user's orbit. The posterior perimeter may be slightly larger than the size of the user's orbit in order to ensure that the user's entire eye can see into the respective lens 1240. For example, the outer edge of each lens 1240 may be aligned with the user's frontal bone in the superior direction (e.g., proximate the user's eyebrow), and may be aligned with the user's maxilla in the inferior direction (e.g., proximate the outer cheek region). The positioning and/or sizing of the lenses 1240 may allow the user to have approximately 360° of peripheral vision in the virtual environment, in order to closely simulate the physical environment.

In some forms, the head-mounted display system 1000 includes a single lens 1240 (e.g., monocular display). The lens 1240 may be positioned anterior to both eyes (e.g., so that both eyes view the image from the display screen 1220 through the lens 1240), or may be positioned anterior to only one eye (e.g., when the image from the displace screen 1220 is viewable by only one eye).

The lenses 1240 may be coupled to a spacer positioned proximate to the display screen 1220 (e.g., between the display screen 1220 and the interfacing structure 1100), so that the lenses 1240 are not in direct contact with the display screen 1220 (e.g., in order to limit the lenses 1240 from scratching the display screen 1220). For example, the lenses 1240 may be recessed relative to the interfacing structure 1100 so that the lenses 1240 are disposed within the viewing opening. In use, each of the user's eyes are aligned with the respective lens 1240 while the user's face is received within the viewing opening (e.g., an operational position). In some forms, the anterior perimeter of each lens 1240 may encompass approximately half of the display screen 1220. A substantially small gap may exist between the two lenses 1240 along a center line of the display screen 1220. This may allow a user looking through both lenses 1240 to be able to view substantially the entire display screen 1220, and all of the images being output to the user. In certain forms, the center of the display screen 1220 (e.g., along the center line between the two lenses 1240) may not output an image. For example, in a binocular display (e.g., where each side of the display screen 1220 outputs substantially the same image), each image may be spaced apart on the display screen 1220. This may allow two lenses 1240 to be positioned in close proximity to the display screen 1220, while allowing the user to view the entirety of the image displayed on the display screen 1220.

In some forms, a protective layer 1242 may be formed around at least a portion of the lenses 1240. In use, the protective layer 1242 may be positioned between the user's face and the display screen 1220. In some forms, a portion of each lens 1240 may project through the protective layer 1242 in the posterior direction. For example, the narrow end of each lens 1240 may project more posterior than the protective layer 1242 in use. In some forms, the protective layer 1242 may be opaque so that light from the display screen 1220 is unable to pass through. Additionally, the user may be unable to view the display screen 1220 without looking through the lenses 1240. In some forms, the protective layer 1242 may be non-planar, and may include contours that substantially match contours of the user's face. For example, a portion of the protective layer 1242 may be recessed in the anterior direction in order to accommodate the user's nose. In certain forms, the user may not contact the protective layer 1242 while wearing the head-mounted display system 1000. This may assist in reducing irritation from additional contact with the user's face (e.g., against the sensitive nasal ridge region).

As shown in FIGS. 2A-2B, the display screen 1220 and/or the display unit housing 1205 of the head-mounted display system 1000 of the present technology may be held in position in use by the positioning and stabilizing structure 1300. To hold the display screen 1220 and/or the display unit housing 1205 in its correct operational position, the positioning and stabilizing structure 1300 is ideally comfortable against the user's head in order to accommodate the induced loading from the weight of the display unit in a manner that minimise facial markings and/or pain from prolonged use. There is also need to allow for a universal fit without trading off comfort, usability and cost of manufacture. The design criteria may include adjustability over a predetermined range with low-touch simple set up solutions that have a low dexterity threshold. Further considerations include catering for the dynamic environment in which the head-mounted display system 1000 may be used. As part of the immersive experience of a virtual environment, users may communicate, i.e., speak, while using the head-mounted display system 1000. In this way, the jaw or mandible of the user may move relative to other bones of the skull. Additionally, the whole head may move during the course of a period of use of the head-mounted display system 1000. For example, movement of a user's upper body, and in some cases lower body, and in particular, movement of the head relative to the upper and lower body.

In one form the positioning and stabilizing structure 1300 provides a retention force to overcome the effect of the gravitational force on the display screen 1220 and/or the display unit housing 1205. In one form of the present technology, a positioning and stabilizing structure 1300 is provided that is configured in a manner consistent with being comfortably worn by a user. In one example the positioning and stabilizing structure 1300 has a low profile, or cross-sectional thickness, to reduce the perceived or actual bulk of the apparatus. In one example, the positioning and stabilizing structure 1300 comprises at least one strap having a rectangular cross-section. In one example the positioning and stabilizing structure 1300 comprises at least one flat strap.

In one form of the present technology, a positioning and stabilizing structure 1300 is provided that is configured so as not to be too large and bulky to prevent the user from comfortably moving their head from side to side. In one form of the present technology, a positioning and stabilizing structure 1300 comprises a strap constructed from a laminate of a textile user-contacting layer, a foam inner layer and a textile outer layer. In one form, the foam is porous to allow moisture, (e.g., sweat), to pass through the strap. In one form, a skin contacting layer of the strap is formed from a material that helps wick moisture away from the user's face. In one form, the textile outer layer comprises loop material to engage with a hook material portion.

In certain forms of the present technology, a positioning and stabilizing structure 1300 comprises a strap that is extensible, e.g., resiliently extensible. For example, the strap may be configured in use to be in tension, and to direct a force to draw the display screen 1220 and/or the display unit housing 1205 toward a portion of a user's face, particularly proximate to the user's eyes and in line with their field of vision. In an example the strap may be configured as a tie.

As shown in FIG. 2C, some forms of the head-mounted display system 1000 or positioning and stabilizing structure 1300 include temporal connectors 1250, each of which may overlay a respective one of the user's temporal bones in use. A portion of the temporal connectors 1250, in-use, are in contact with a region of the user's head proximal to the otobasion superior, i.e., above each of the user's ears. In some examples, temporal connectors are strap portions of a positioning and stabilizing structure 1300. In other examples, temporal connectors are arms of a head-mounted display unit 1200. In some examples a temporal connector of a head-mounted display system 1000 may be formed partially by a strap portion (e.g., a lateral strap portion 1330) of a positioning and stabilizing structure 1300 and partially by an arm 1210 of a head-mounted display unit 1200.

The temporal connectors 1250 may be lateral portions of the positioning and stabilizing structure 1300, as each temporal connector 1250 is positioned on either the left or the right side of the user's head. In some forms, the temporal connectors 1250 may extend in an anterior-posterior direction, and may be substantially parallel to the sagittal plane. In some forms, the temporal connectors 1250 may be coupled to the display unit housing 1205. For example, the temporal connectors 1250 may be connected to lateral sides of the display unit housing 1205. For example, each temporal connector 1250 may be coupled to a respective one of the lateral left face 1234 and the lateral right face 1236. In certain forms, the temporal connectors 1250 may be pivotally connected to the display unit housing 1205, and may provide relative rotation between each temporal connector 1250, and the display unit housing 1205. In certain forms, the temporal connectors 1250 may be removably connected to the display unit housing 1205 (e.g., via a magnet, a mechanical fastener, hook and loop material, etc.). In some forms, the temporal connectors 1250 may be arranged in-use to run generally along or parallel to the Frankfort Horizontal plane of the head and superior to the zygomatic bone (e.g., above the user's cheek bone). In some forms, the temporal connectors 1250 may be positioned against the user's head similar to arms of eye-glasses, and be positioned more superior than the anti-helix of each respective ear.

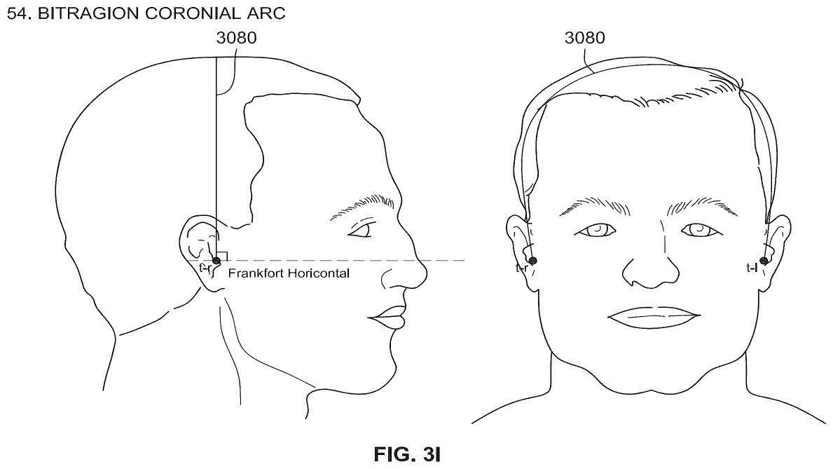

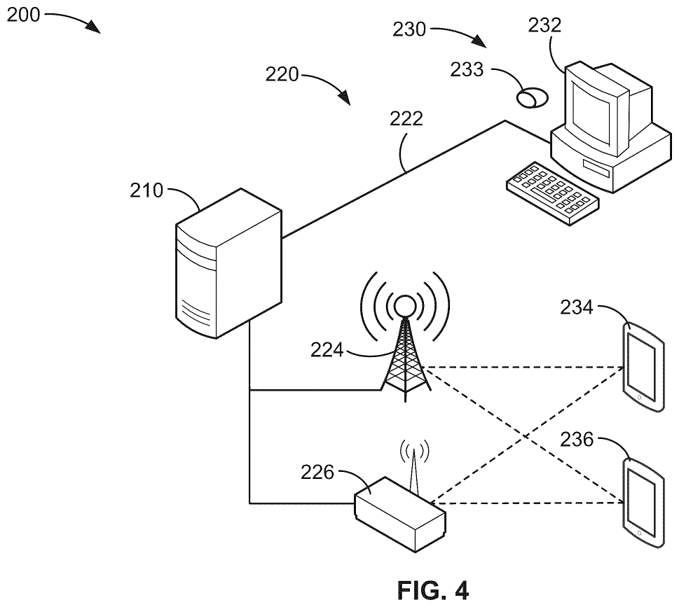

As shown in FIG. 2C, some forms of the positioning and stabilizing structure 1300 may include a posterior support portion 1350 for assisting in supporting the display screen and/or the display unit housing 1205 (shown in FIG. 4B) proximate to the user's eyes. The posterior support portion 1350 may assist in anchoring the display screen and/or the display unit housing 1205 to the user's head in order to appropriately orient the display screen proximate to the user's eyes.

In some forms, the posterior support portion 1350 may be coupled to the display unit housing 1205 via the temporal connectors 1250. In certain forms, the temporal connectors 1250 may be directly coupled to the display unit housing 1205 and to the posterior support portion 1350. In some forms, the posterior support portion 1350 may have a three-dimensional contour curve to fit to the shape of a user's head. For example, the three-dimensional shape of the posterior support portion 1350 may have a generally round three-dimensional shape adapted to overlay a portion of the parietal bone and the occipital bone of the user's head, in use. In some forms, the posterior support portion 1350 may be a posterior portion of the positioning and stabilizing structure 1300. The posterior support portion 1350 may provide an anchoring force directed at least partially in the anterior direction.

In certain forms, the posterior support portion 1350 is the inferior-most portion of the positioning and stabilizing structure 1300. For example, the posterior support portion 1350 may contact a region of the user's head between the occipital bone and the trapezius muscle. The rear support 3008 may hook against an inferior edge of the occipital bone (e.g., the occiput). The posterior support portion 1350 may provide a force directed in the superior direction and/or the anterior direction in order to maintain contact with the user's occiput. In certain forms, the posterior support portion 1350 is the inferior-most portion of the entire head-mounted display system 1000. For example, the posterior support portion 1350 may be positioned at the base of the user's neck (e.g., overlaying the occipital bone and the trapezius muscle more inferior than the user's eyes) so that the posterior support portion 1350 is more inferior than the display screen 1220 and/or the display unit housing 1205. In some forms, the posterior support portion 1350 may include a padded material, which may contact the user's head (e.g., overlaying the region between the occipital bone and the trapezius muscle). The padded material may provide additional comfort to the user, and limit marks caused by the posterior support portion 1350 pulling against the user's head.

Some forms of the positioning and stabilizing structure 1300 may include a forehead support or frontal support portion 1360 that configured to contact the user's head superior to the user's eyes, while in use. The positioning and stabilizing structure 1300 shown in FIG. 2B includes a forehead support 1360. In some examples the positioning and stabilizing structure 1300 shown in FIG. 2A may include a forehead support 1360. The forehead support 1360 may overlay the frontal bone of the user's head. In certain forms, the forehead support 1360 may also be more superior than the sphenoid bones and/or the temporal bones. This may also position the forehead support 1360 more superior than the user's eyebrows.

In some forms, the forehead support 1360 may be an anterior portion of the positioning and stabilizing structure 1300, and may be disposed more anterior on the user's head than any other portion of the positioning and stabilizing structure 1300. The posterior support portion 1350 may provide a force directed at least partially in the posterior direction.

In some forms, the forehead support 1360 may include a cushioning material (e.g., textile, foam, silicone, etc.) that may contact the user, and may help to limit marks caused by the straps of the positioning and stabilizing structure 1300. The forehead support 1360 and the interfacing structure 1100 may work together in order to provide comfort to the user.

In some forms, the forehead support 1360 may be separate from the display unit housing 1205, and may contact the user's head at a different location (e.g., more superior) than the display unit housing 1205. In some forms, the forehead support 1360 can be adjusted to allow the positioning and stabilizing structure 1300 to accommodate the shape and/or configuration of a user's face. In some forms, the temporal connectors 1250 may be coupled to the forehead support 1360 (e.g., on lateral sides of the forehead support 1360). The temporal connectors 1250 may extend at least partially in the inferior direction in order to couple to the posterior support portion 1350.

In certain forms, the positioning and stabilizing structure 1300 may include multiple pairs of temporal connectors 1250. For example, one pair of temporal connectors 1250 may be coupled to the forehead support 1360, and one pair of temporal connectors 1250 may be coupled to the display unit housing 1205. In some forms, the forehead support 1360 can be presented at an angle which is generally parallel to the user's forehead to provide improved comfort to the user. For example, the forehead support 1360 may position the user in an orientation that overlays the frontal bone, and is substantially parallel to the coronal plane. Positioning the forehead support substantially parallel to the coronal plane can reduce the likelihood of pressure sores which may result from an uneven presentation.

In some forms, the forehead support 1360 may be offset from a rear support or posterior support portion that contacts a posterior region of the user's head (e.g., an area overlaying the occipital bone and the trapezius muscle). In other words, an axis along a rear strap would not intersect the forehead support 1360, which may be disposed more inferior and anterior than the axis along the rear strap. The resulting offset between the forehead support 1360 and the rear strap may create moments that oppose the weight force of the display screen 1220 and/or the display unit housing 1205. A larger offset may create a larger moment, and therefore more assistance in maintaining a proper position of the display screen 1220 and/or the display unit housing 1205. The offset may be increased by moving the forehead support 1360 closer to the user's eyes (e.g., more anterior and inferior along the user's head), and/or increasing the angle of the rear strap so that it is more vertical.

In some forms, the display unit housing 1205 may include at least one loop or eyelet 1254, and at least one of the temporal connectors 1250 may be threaded through that loop, and doubled back on itself. The length of the temporal connector 1250 threaded through the respective eyelet 1254 may be selected by the user in order to adjust the tensile force provided by the positioning and stabilizing structure 1300. For example, threading a greater length of the temporal connector 1250 through the eyelet 1254 may supply a greater tensile force.

In some forms, at least one of the temporal connectors 1250 may include an adjustment portion 1256 and a receiving portion 1258. The adjustment portion 1256 may be positioned through the eyelet 1254 on the display unit housing 1205, and may be coupled to the receiving portion 1258 (e.g., by doubling back on itself). The adjustment portion 1256 may include a hook material, and the receiving portion 1258 may include a loop material (or vice versa), so that the adjustment portion 1256 may be removably held in the desired position. In some examples, the hook material and the loop material may be Velcro.

In some forms, the positioning and stabilizing structure 1300 may include a top strap portion 1340, which may overlay a superior region of the user's head. In some forms, the top strap portion 1340 may extend between an anterior portion of the head-mounted display system 1000 and a posterior region of the head-mounted display system 1000. In some forms, the top strap portion 1340 may be constructed from a flexible material, and may be configured to compliment the shape of the user's head.

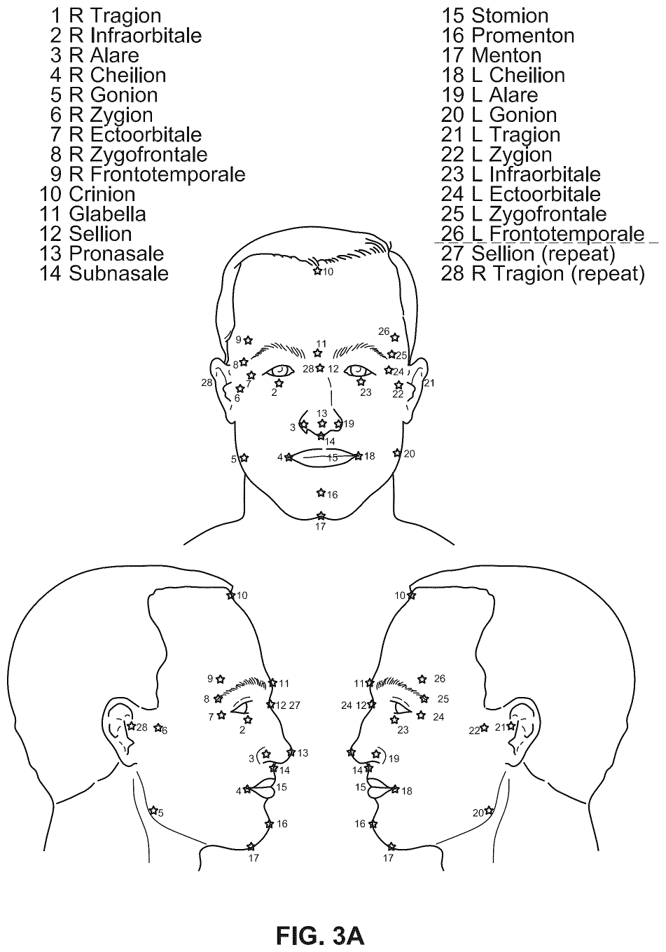

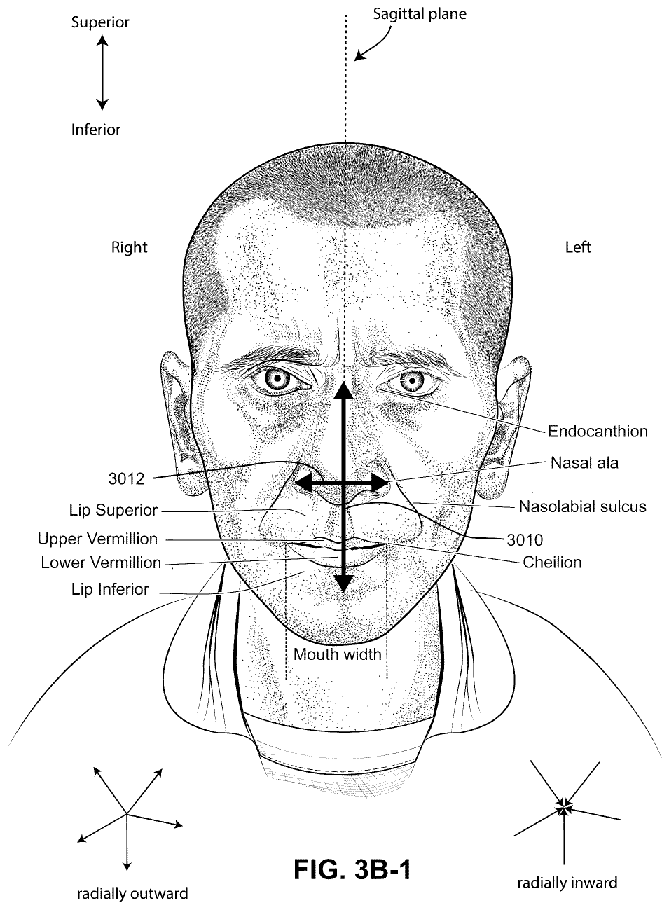

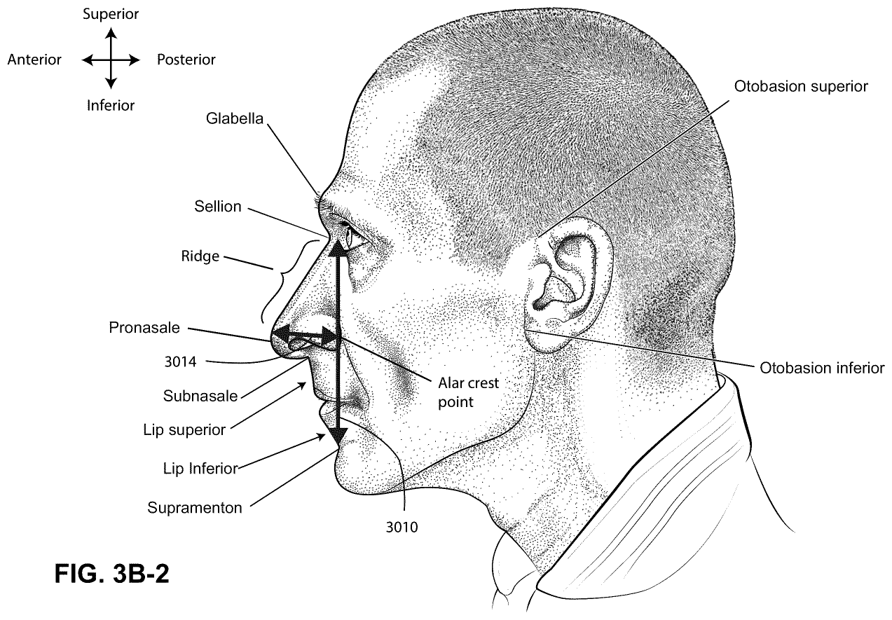

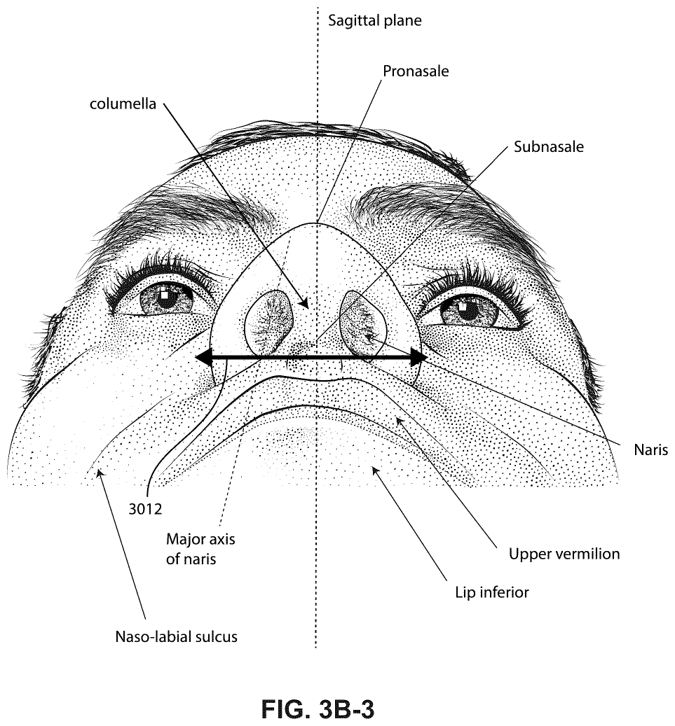

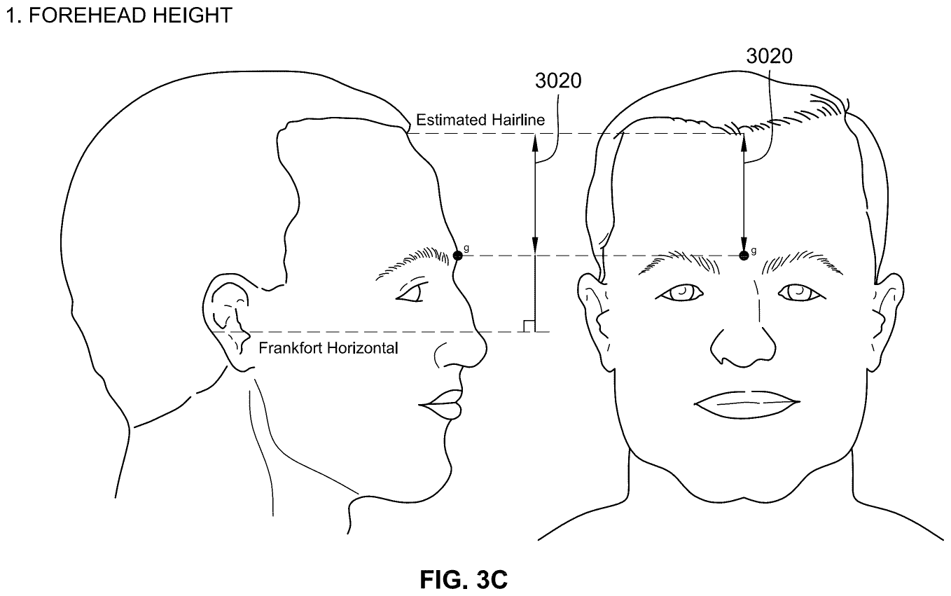

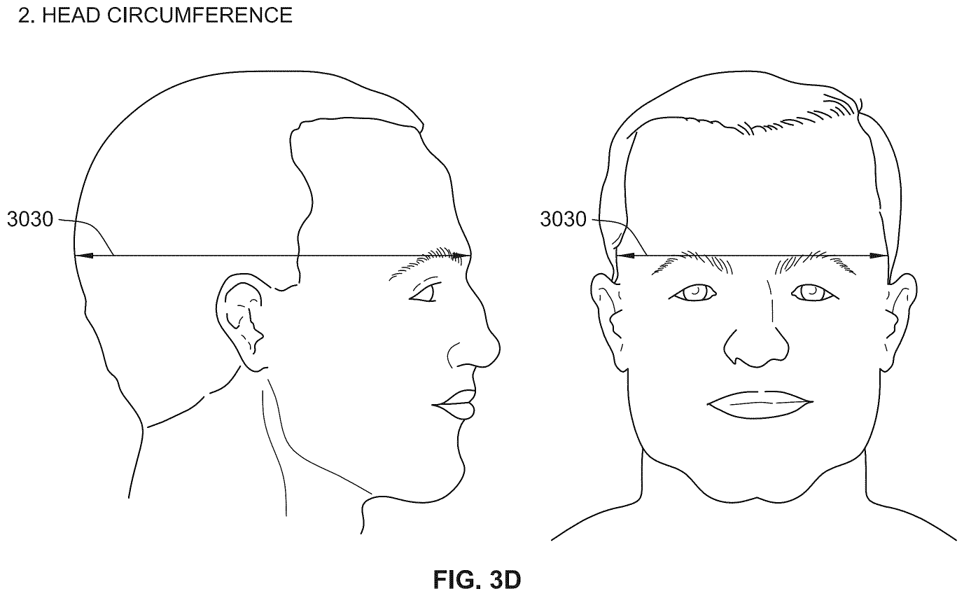

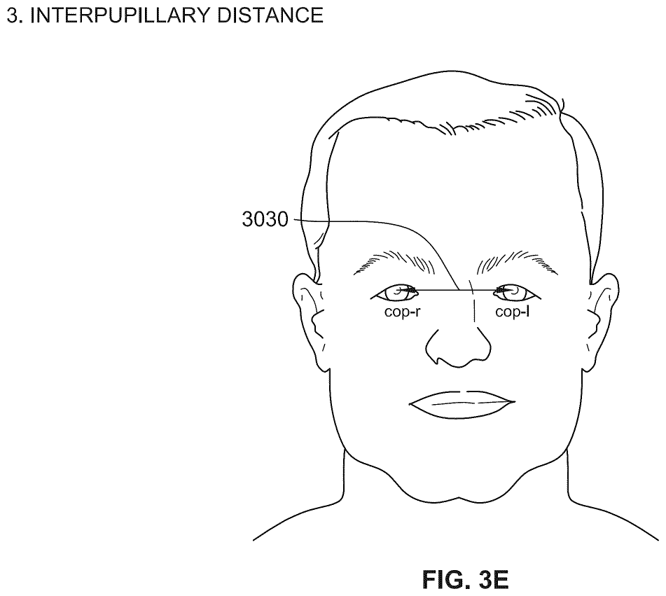

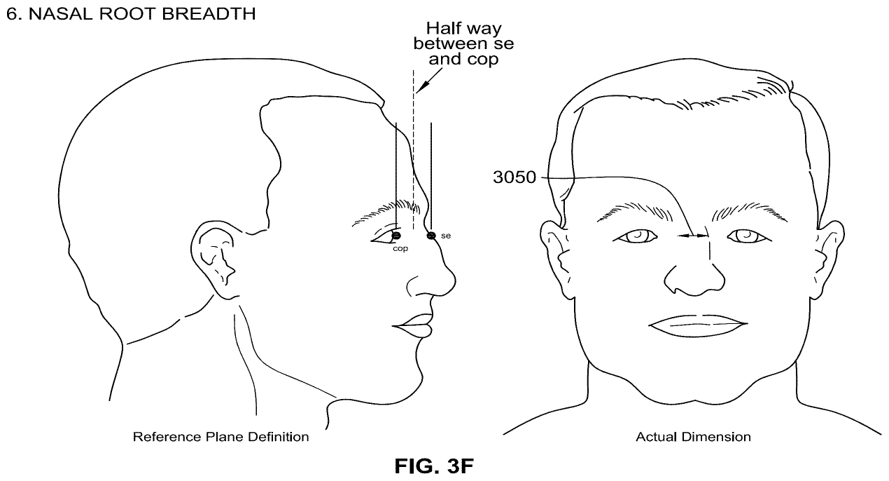

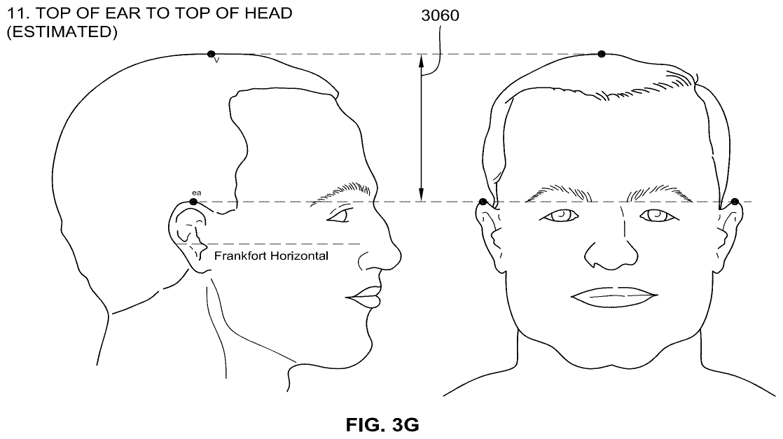

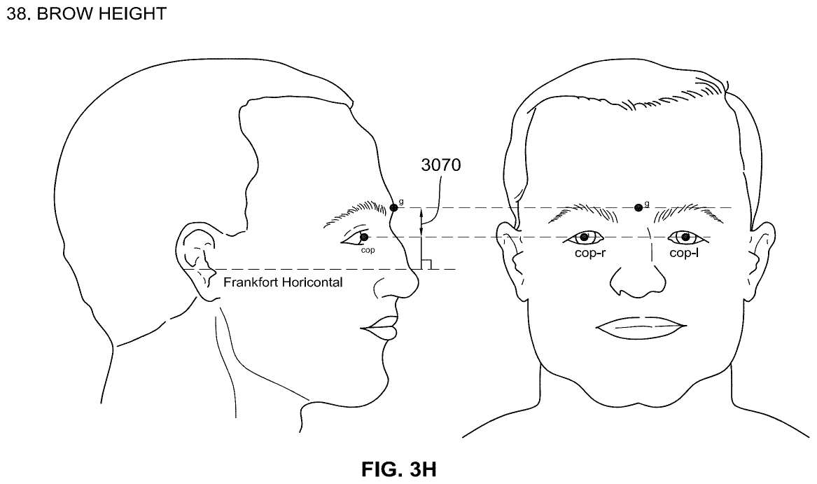

FIG. 3A shows an anterior view of a human face including features such as the endocanthion, nasal ala, nasolabial sulcus, lip superior and inferior, upper and lower vermillion, and chelion. Also shown are the mouth width, the sagittal plane dividing the head into left and right portions, and directional indicators. The directional indicators indicate radial inward/outward and superior/inferior directions. FIG. 3A also shows a lateral view of a human face including the glabella, sellion, nasal ridge, pronasale, subnasale, superior and inferior lip, supramenton, alar crest point, and otobasion superior and inferior.

The following are more detailed explanations of the features of the human face shown in FIG. 3A.

Ala: The external outer wall or “wing” of each nostril (plural: alar)

Alare: The most lateral point on the nasal ala.

Alar curvature (or alar crest) point: The most posterior point in the curved base line of each ala, found in the crease formed by the union of the ala with the cheek.

Auricle: The whole external visible part of the ear.

Columella: The strip of skin that separates the nares and which runs from the pronasale to the upper lip.

Columella angle: The angle between the line drawn through the midpoint of the nostril aperture and a line drawn perpendicular to the Frankfurt horizontal while intersecting subnasale.

Glabella: Located on the soft tissue, the most prominent point in the midsagittal plane of the forehead.

Nares (Nostrils): Approximately ellipsoidal apertures forming the entrance to the nasal cavity. The singular form of nares is naris (nostril). The nares are separated by the nasal septum.

Naso-labial sulcus or Naso-labial fold: The skin fold or groove that runs from each side of the nose to the corners of the mouth, separating the cheeks from the upper lip.

Naso-labial angle: The angle between the columella and the upper lip, while intersecting subnasale.

Otobasion inferior: The lowest point of attachment of the auricle to the skin of the face.

Otobasion superior: The highest point of attachment of the auricle to the skin of the face.

Pronasale: The most protruded point or tip of the nose, which can be identified in lateral view of the rest of the portion of the head.

Philtrum: The midline groove that runs from lower border of the nasal septum to the top of the lip in the upper lip region.

Pogonion: Located on the soft tissue, the most anterior midpoint of the chin.

Ridge (nasal): The nasal ridge is the midline prominence of the nose, extending from the Sellion to the Pronasale.

Sagittal plane: A vertical plane that passes from anterior (front) to posterior (rear) dividing the body into right and left halves.

Sellion: Located on the soft tissue, the most concave point overlying the area of the frontonasal suture.

Septal cartilage (nasal): The nasal septal cartilage forms part of the septum and divides the front part of the nasal cavity.

Subalare: The point at the lower margin of the alar base, where the alar base joins with the skin of the superior (upper) lip.

Subnasal point: Located on the soft tissue, the point at which the columella merges with the upper lip in the midsagittal plane.

Supramenton: The point of greatest concavity in the midline of the lower lip between labrale inferius and soft tissue pogonion.

As will be explained below, there are several relevant dimensions and features from a face that may be used to select the sizing for an interfacing structure such as the interfacing structure 1100 for the head-mounted display system 1000 in FIGS. 1-2. FIG. 3A shows front and side views of different relevant dimensions and features for the described methods of customizing VR/AR headwear for an individual user. Thus, FIG. 3A shows landmarks used to determine the distance between the eyes, the angle of the nose, and the head width as well as hairline, points around eye sockets, and points around eyes and eyebrows. FIGS. 3B-3I show other relevant dimensions for designing user customized VR/AR headwear.

FIG. 3B-1 shows a front view, FIG. 3B-2 shows a side view, and FIG. 3B-3 shows a base view, of three dimensions relating to the face and the nose. FIG. 3B-3 shows a base view of a nose with several features identified including naso-labial sulcus, lip inferior, upper Vermilion, naris, subnasale, columella, pronasale, the major axis of a naris and the sagittal plane. A line 3010 represents the face height, which is the distance between the sellion to the supramenton. A line 3012 in FIGS. 3B-1 and 3B-3 represents the nose width, which is between the left and right alar points of the nose. A line 3014 in FIG. 3B-2 represents the nose depth.

FIG. 3C is a side view and front of a head with a forehead height dimension 3020 identified. The forehead height dimension 3020 is the vertical height (perpendicular to the Frankfort horizontal) between the glabella on the brow and the estimated hairline. FIG. 3D is a front view of a head with a forehead height dimension 3030 identified. The head circumference is measured at the level of the most protruding point of the brow, parallel to the Frankfort Horizontal. FIG. 3E is a side view and front of a head with an interpupillary distance dimension 3040 identified. The interpupillary distance dimension is the straight line distance between the center of the two pupils (cop-r, cop-1).

FIG. 3F is a side view and front of a head with a nasal root breadth dimension 3050 identified. The nasal root breadth dimension is the horizontal breadth of the nose at the height of the deepest depression in the root (Sellion landmark) measured on a plane at a depth equal to one-half the distance from the bridge of the nose to the eyes. FIG. 3G is a side view and front of a head with a top of ear to top of head distance dimension 3060 identified. The top of ear to top of head distance dimension is the vertical distance, projected to the mid sagittal plane, perpendicular to the Frankfort horizontal from the top of the ear to the top of the head.

FIG. 3H is a side view and front of a head with a brow height dimension 3070 identified. The brow height dimension g is the vertical height between the center of the pupils (cop-r, cop-1) and the anterior point of the frontal bone at the brow. The distance is measured perpendicular to the Frankfort horizontal. The recorded value is the average of the left and right pupil distances. FIG. 3I is a side view and front of a head with a bitragion coronial arc dimension 3080 identified. The bitragion coronial arc dimension is the arc over the top of the head from one tragion right (t-r) to tragion left (t-1), when the head is in the Frankfort plane.

Thus, the present technology allows users to more quickly and conveniently obtain a VR interface, AR interface, or MR interface, such as a head-mounted display interface by data from facial features of the individual user determined by a scanning process. A scanning process allows a user quickly measure their facial anatomy from the comfort of their own home using a computing device, such as a desktop computer, tablet, smart phone or other mobile device. Facial data may also be gathered in other ways such as from pre-stored facial images. Such pre-stored facial images are optimally used when taken as recently as possible as facial features may change over time. The scanning process may utilize any technique known in the art for identifying relevant landmarks on an image of a user. For example, Computer Vision (CV) techniques and/or Machine Learning (ML) may be used to identify landmarks on the image of the user. These techniques may be semi-automated, incorporating manual identification for landmarks that were not identified by the CV or ML technique, or they may be fully automated. In some instances, a fully manual process may be employed whereby the landmarks are manually identified on the image. The manual identification may be guided by instructions displayed on a computing device. The manual identification may be performed by the user or a third party.

In this example, an application downloadable from a manufacturer or third party server to a smartphone or tablet with an integrated camera may be used to collect facial data. When launched, the application may provide visual and/or audio instructions. As instructed, the user may stand in front of a mirror, and press the camera button on a user interface. An activated process may then take a series of pictures of the user's face (preferably from different angles and locations), and then obtain facial dimensions for selection of an interface (based on the processor analyzing the pictures). As will be explained below, such an application may be used to collect additional selections for other features of the head-mounted display interface.

A user may capture an image or series of images of their facial structure. Instructions provided by an application stored on a computer-readable medium, such as when executed by a processor, detect various facial landmarks within the images, measure and scale the distance between such landmarks, compare these distances to a data record, and allow for the production of a customized head mounted display interface. There may several to several thousand landmarks. 2D pixel coordinates may be converted to 3D coordinates for 3D analysis of the distances. Alternatively, the application may recommend an appropriate head mounted display interface from existing models.

FIG. 4 depicts an example system 200 that may be implemented for collecting facial feature data from users. The system 200 may also include automatic facial feature measuring. System 200 may generally include one or more of servers 210, a communication network 220, and a computing device 230. Server 210 and computing device 230 may communicate via communication network 220, which may be a wired network 222, wireless network 224, or wired network with a wireless link 226. In some versions, server 210 may communicate one-way with computing device 230 by providing information to computing device 230, or vice versa. In other embodiments, server 210 and computing device 230 may share information and/or processing tasks. The system may be implemented, for example, to permit automated purchase of head mounted display interfaces where the process may include automatic sizing processes described in more detail herein. For example, a customer may order a head mounted display online after running a facial selection process that automatically identifies a suitable head mounted display size by image analysis of the customer's facial features.

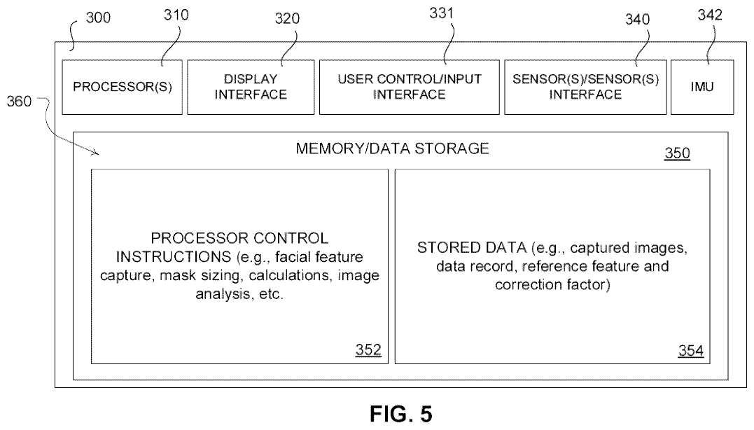

The computing device 230 can be a desktop or laptop computer 232 or a mobile device, such as a smartphone 234 or tablet 236. FIG. 5 depicts the general architecture 300 of the computing device 230. The computing device 230 may include one or more processors 310. The computing device 230 may also include a display interface 320, user control/input interface 331, sensor 340 and/or a sensor interface for one or more sensor(s), inertial measurement unit (IMU) 342 and non-volatile memory/data storage 350.

Sensor 340 may be one or more cameras (e.g., a CCD charge-coupled device or active pixel sensors) that are integrated into computing device 230, such as those provided in a smartphone or in a laptop. Alternatively, where the computing device 230 is a desktop computer, device 230 may include a sensor interface for coupling with an external camera, such as the webcam 233 depicted in FIG. 5. Other exemplary sensors that could be used to assist in the methods described herein that may either be integral with or external to the computing device include stereoscopic cameras, for capturing three-dimensional images, or a light detector capable of detecting reflected light from a laser or strobing/structured light source.

User control/input interface 331 allows the user to provide commands or respond to prompts or instructions provided to the user. This could be a touch panel, keyboard, mouse, microphone, and/or speaker, for example.

The display interface 320 may include a monitor, LCD panel, or the like to display prompts, output information (such as facial measurements or head mounted display size recommendations), and other information, such as a capture display, as described in further detail below.

Memory/data storage 350 may be the computing device's internal memory, such as RAM, flash memory or ROM. In some embodiments, memory/data storage 350 may also be external memory linked to computing device 230, such as an SD card, server, USB flash drive or optical disc, for example. In other embodiments, memory/data storage 350 can be a combination of external and internal memory. Memory/data storage 350 includes stored data 354 and processor control instructions 352 that instruct processor 310 to perform certain tasks. Stored data 354 can include data received by sensor 340, such as a captured image, and other data that is provided as a component part of an application. Processor control instructions 352 can also be provided as a component part of an application.

As explained above, a facial image may be captured by a mobile computing device such as the smartphone 234. An appropriate application executed on the computing device 230 or the server 210 can provide three-dimensional relevant facial data to assist in selection of an appropriate VR/AR head mounted display interface. The application may use any appropriate method of facial scanning.

One such application is an application 360 for facial feature measuring and/or user data collection, which may be an application downloadable to a mobile device, such as smartphone 234 and/or tablet 236. The application 360 may also collect facial features and data of user who have already been using head mounted display interfaces for better collection of feedback from such interfaces. The application 360, which may be stored on a computer-readable medium, such as memory/data storage 350, includes programmed instructions for processor 310 to perform certain tasks related to facial feature measuring. The application also includes data that may be processed by the algorithm of the automated methodology. Such data may include a data record, reference feature, and correction factors, as explained in additional detail below.

The application 360 is executed by the processor 310, to measure user facial features using two-dimensional or three-dimensional images and to provide a customized head mounted display. The method may generally be characterized as including three or four different phases: a pre-capture phase, a capture phase, a post-capture image processing phase, and a comparison and output phase.

In some cases, the application for facial feature measuring may control a processor 310 to output a visual display that includes a reference feature on the display interface 320. Preferably the reference feature is placed on the forehead to avoid distance scaling issues. The user may position the feature adjacent to their facial features, such as by movement of the camera. Alternatively, the reference feature may be part of the face such as an eye iris. The processor may then capture and store one or more images of the facial features in association with the reference feature when certain conditions, such as alignment conditions are satisfied. This may be done with the assistance of a mirror. The mirror reflects the displayed reference feature and the user's face to the camera. The application then controls the processor 310 to identify certain facial features within the images and measure distances therebetween. By image analysis processing a scaling factor may then be used to convert the facial feature measurements, which may be pixel counts, to standard mask measurement values based on the reference feature. Such values may be, for example, standardized unit of measure, such as a meter or an inch, and values expressed in such units suitable for mask sizing.

Additional correction factors may be applied to the measurements. The facial feature measurements may be compared to data records that include measurement ranges corresponding to different support interface sizes for particular user head mounted display interface forms. Such a process may be conveniently affected within the comfort of any preferred user location. The application may perform this method within seconds. In one example, the application performs this method in real time.

In the pre-capture phase, the processor 310, among other things, assists the user in establishing the proper conditions for capturing one or more images for sizing processing. Some of these conditions include proper lighting and camera orientation and motion blur caused by an unsteady hand holding the computing device 230, for example.

A user may conveniently download an application for performing the automatic measuring and sizing at computing device 230 from a server, such as a third party application-store server, onto their computing device 230. When downloaded, such application may be stored on the computing device's internal non-volatile memory, such as RAM or flash memory. Computing device 230 is preferably a mobile device, such as smartphone 234 or tablet 236.

When the user launches the application, the processor 310 may prompt the user via the display interface 320 to provide user specific information. However, the processor 310 may prompt to the user to input this information at any time, such as after the user's facial features are measured and after the user uses the head mounted display interface. The processor 310 may also present a tutorial, which may be presented audibly and/or visually, as provided by the application to aid the user in understanding their role during the process. The prompts may also require information for features of the head mounted display interface design. Also, in the pre-capture phase, the application may extrapolate the user specific information based on information already gathered by the user, such as after receiving captured images of the user's face, and based on machine learning techniques or through artificial intelligence. Other information may also be collected through interfaces as will be explained below.

When the user is prepared to proceed, which may be indicated by a user input or response to a prompt via user control/input interface 331, the processor 310 activates the sensor 340 as instructed by the processor control instructions 352. The sensor 340 is preferably the mobile device's forward facing camera, which is located on the same side of the mobile device as display interface 320. The camera is generally configured to capture two-dimensional images. Mobile device cameras that capture two-dimensional images are ubiquitous. The present technology takes advantage of this ubiquity to avoid burdening the user with the need to obtain specialized equipment.

Around the same time the sensor/camera 340 is activated, the processor 310, as instructed by the application, presents a capture display on the display interface 320. The capture display may include a camera live action preview, a reference feature, a targeting box, and one or more status indicators or any combination thereof. In this example, the reference feature is displayed centered on the display interface and has a width corresponding to the width of the display interface 320. The vertical position of the reference feature may be such that the top edge of reference feature abuts the upper most edge of the display interface 320 or the bottom edge of reference feature abuts the lower most edge of the display interface 320. A portion of the display interface 320 will display the camera live action preview 324, typically showing the user's facial features captured by the sensor/camera 340 in real time if the user is in the correct position and orientation.

The reference feature is a feature that is known to computing device 230 (predetermined) and provides a frame of reference to processor 310 that allows processor 310 to scale captured images. The reference feature may preferably be a feature other than a facial or anatomical feature of the user. Thus, during the image processing phase, the reference feature assists processor 310 in determining when certain alignment conditions are satisfied, such as during the pre-capture phase. The reference features may be a quick response (QR) code or known exemplar or marker, which can provide processor 310 certain information, such as scaling information, orientation, and/or any other desired information which can optionally be determined from the structure of the QR code. The QR code may have a square or rectangular shape. When displayed on display interface 320, the reference feature has predetermined dimensions, such as in units of millimeters or centimeters, the values of which may be coded into the application and communicated to processor 310 at the appropriate time. The actual dimensions of reference feature 326 may vary between various computing devices. In some versions, the application may be configured to be a computing device model-specific in which the dimensions of reference feature 326, when displayed on the particular model, is already known. However, in other embodiments, the application may instruct processor 310 to obtain certain information from device 230, such as display size and/or zoom characteristics that allow the processor 310 to compute the real world/actual dimensions of the reference feature as displayed on display interface 320 via scaling. Regardless, the actual dimensions of the reference feature as displayed on the display interfaces 320 of such computing devices are generally known prior to post-capture image processing.

Along with the reference feature, the targeting box may be displayed on display interface 320. The targeting box allows the user to align certain components within capture display 322 in targeting box, which is desired for successful image capture.

The status indicator provides information to the user regarding the status of the process. This helps ensure the user does not make major adjustments to the positioning of the sensor/camera prior to completion of image capture.

Thus, when the user holds display interface 320 parallel to the facial features to be measured and presents user display interface 320 to a mirror or other reflective surface, the reference feature is prominently displayed and overlays the real-time images seen by camera/sensor 340 and as reflected by the mirror. This reference feature may be fixed near the top of display interface 320. The reference feature is prominently displayed in this manner at least partially so that sensor 340 can clearly see the reference feature so that processor 310 can easily identify the feature. In addition, the reference feature may overlay the live view of the user's face, which helps avoid user confusion.

The user may also be instructed by processor 310, via display interface 320, by audible instructions via a speaker of the computing device 230, or be instructed ahead of time by the tutorial, to position display interface 320 in a plane of the facial features to be measured. For example, the user may be instructed to position display interface 320 such that it is facing anteriorly and placed under, against, or adjacent to the user's chin in a plane aligned with certain facial features to be measured. For example, display interface 320 may be placed in planar alignment with the sellion and suprementon. As the images ultimately captured are two-dimensional, planar alignment helps ensure that the scale of reference feature 326 is equally applicable to the facial feature measurements. In this regard, the distance between the mirror and both of the user's facial features and the display will be approximately the same. Other instructions may be given to the user. For example, the user may be instructed to remove or move objects such as glasses or hair that may block facial features. A user may also be instructed to make a neutral facial expression most conducive to capturing desired images or not to blink if an iris is used as a reference feature.

When the user is positioned in front of a mirror, and the display interface 320, which includes the reference feature, is roughly placed in planar alignment with the facial features to be measured, the processor 310 checks for certain conditions to help ensure sufficient alignment. One exemplary condition that may be established by the application, as previously mentioned, is that the entirety of the reference feature must be detected within targeting box 328 in order to proceed. If the processor 310 detects that the reference feature is not entirely positioned within targeting box, the processor 310 may prohibit or delay image capture. The user may then move their face along with display interface 320 to maintain planarity until the reference feature, as displayed in the live action preview, is located within targeting box. This helps optimized alignment of the facial features and display interface 320 with respect to the mirror for image capture.

When processor 310 detects the entirety of reference feature within targeting box, processor 310 may read the IMU 342 of the computing device for detection of device tilt angle. The IMU 342 may include an accelerometer or gyroscope, for example. Thus, the processor 310 may evaluate device tilt such as by comparison against one or more thresholds to ensure it is in a suitable range. For example, if it is determined that computing device 230, and consequently display interface 320 and user's facial features, is tilted in any direction within about ±5 degrees, the process may proceed to the capture phase. In other embodiments, the tilt angle for continuing may be within about ±10 degrees, ±7 degrees, ±3 degrees, or ±1 degree. If excessive tilt is detected a warning message may be displayed or sounded to correct the undesired tilt. This is particularly useful for assisting the user to help prohibit or reduce excessive tilt, particularly in the anterior-posterior direction, which if not corrected, could pose as a source of measuring error as the captive reference image will not have a proper aspect ratio.

When alignment has been determined by the processor 310 as controlled by the application, the processor 310 proceeds into the capture phase. The capture phase preferably occurs automatically once the alignment parameters and any other conditions precedent are satisfied. However, in some embodiments, the user may initiate the capture in response to a prompt to do so.

When image capture is initiated, the processor 310 via the sensor 340 captures a number n of images, which is preferably more than one image. For example, the processor 310 via the sensor 340 may capture about 5 to 20 images, 10 to 20 images, or 10 to 15 images, etc. The quantity of images captured may be sequential such as a video. In other words, the number of images that are captured may be based on the number of images of a predetermined resolution that can be captured by sensor 340 during a predetermined time interval. For example, if the number of images sensor 340 can capture at the predetermined resolution in 1 second is 40 images and the predetermined time interval for capture is 1 second, the sensor 340 will capture 40 images for processing with the processor 310. A sequence of image may be helpful in reducing flutter of the landmark locations using ML methods such as optical flow. The quantity of images may be user-defined, determined by the server 210 based on artificial intelligence or machine learning of environmental conditions detected, or based on an intended accuracy target. For example, if high accuracy is required then more captured images may be required. Although, it is preferable to capture multiple images for processing, one image is contemplated and may be successful for use in obtaining accurate measurements. However, more than one image allows average measurements to be obtained. This may reduce error/inconsistencies and increase accuracy. The images may be placed by the processor 310 in the stored data 354 of the memory/data storage device 350 for post-capture processing.

In addition, accuracy may be enhanced by images from multiple views, especially for 3D facial shapes. For such 3D facial shapes, a front image, a side profile and some images in between may be used to capture the face shape. In relation head gear size estimations, images of the sides, top, and back of the head may increase accuracy in relation to head gear. When combining landmarks from multiple views, averaging can be done, but averaging suffers from inherent inaccuracy. Some uncertainty is assigned to landmark location, and landmarks are then weighted by uncertainty during reconstruction. For example, landmarks from a frontal image will be used to reconstruct the front part of the face, and landmarks from profile shots will we used to reconstruct the sides of the head. Typically, the images will be associated with the pose of the head (angles of rotation). In this manner, it is ensured that a number of images from different views are captured. For example, if eye iris is used as the scaling features, then images where the iris is closed (e.g., when the user blinks) need to be discarded as they cannot be scaled. This is another reason to require multiple images as certain images that may not be useful may be discarded without requesting rescan.

Once the images are captured, the images are processed by processor 310 to detect or identify facial features/landmarks and measure distances therebetween. The resultant measurements may be used to recommend an appropriate head-mounted display interface size. This processing may alternatively be performed by server 210 receiving the transmitted captured images and/or on the user's computing device (e.g., smart phone). Processing may also be undertaken by a combination of the processor 310 and the server 210.

The processor 310, as controlled by the application, retrieves one or more captured images from the stored data 354. The image is then extracted by the processor 310 to identify each pixel comprising the two-dimensional captured image. The processor 310 then detects certain pre-designated facial features within the pixel formation.

Detection may be performed by the processor 310 using edge detection, such as Canny, Prewitt, Sobel, Robert's edge detection, and more advanced deep neural networks (DNNs) such as Convolutional Neural Networks (CNNs) based methods. These edge detection techniques/algorithms help identify the location of certain facial features within the pixel formation, which correspond to the user's actual facial features as presented for image capture. For example, the edge detection techniques can first identify the user's face within the image and also identify pixel locations within the image corresponding to specific facial features, such as each eye and borders thereof, the mouth and corners thereof, left and right alares, sellion, supramenton, glabella and left and right nasolabial sulci, etc. Multiple landmarks may be used instead of edge detection. The processor 310 may then mark, tag or store the particular pixel location(s) of each of these facial features. Alternatively, or if such detection by the processor 310/server 210 is unsuccessful, the pre-designated facial features may be manually detected and marked, tagged or stored by a human operator with viewing access to the captured images through a user interface of the processor 310/server 210.

Once the pixel coordinates for these facial features are identified, the application controls the processor 310 to measure the pixel distance between certain of the identified features. For example, the distance may generally be determined by the number of pixels for each feature and may include scaling. For example, measurements between the left and right alares may be taken to determine pixel width of the nose and/or between the sellion and supramenton to determine the pixel height of the face. Other examples include pixel distance between each eye, between mouth corners, and between left and right nasolabial sulci to obtain additional measurement data of particular structures like the mouth. Further distances between facial features can be measured. In this example, certain facial dimensions are used for the process of providing a customized head-mounted display interface to a user.

Other methods for facial identification may be used. For example, fitting of 3D morphable models (3DMMs) to the 2D images using DNNs may be employed. The end result of such DNN methods is a full 3D surface (comprised of thousands of vertices) of the face, ears and head that may all be predicted from a single image or multiple multi-view images. Differential rendering, which involves using photometric loss to fit the model, may be applied. This minimizes the error (including at a pixel level) between a rendered version of the 3DMM and the image.

Once the pixel measurements of the pre-designated facial features are obtained, an anthropometric correction factor(s) may be applied to the measurements. It should be understood that this correction factor can be applied before or after applying a scaling factor, as described below. The anthropometric correction factor can correct for errors that may occur in the automated process, which may be observed to occur consistently from user to user. In other words, without the correction factor, the automated process, alone, may result in consistent results from user to user, but results that may lead to a certain amount of mis-sized interfaces. Ideally the accuracy of the face landmark predictions should be able to easily distinguish between sizes of the interface. If there are only 1-2 interface sizes, then this may require an accuracy of 2-3 mm. As the number of interface sizes increases, the accuracy range is decreased to 1-2 mm or lower. The correction factor, which may be empirically extracted from population testing, shifts the results closer to a true measurement helping to reduce or eliminate mis-sizing. This correction factor can be refined or improved in accuracy over time as measurement and sizing data for each user is communicated from respective computing devices to the server 210 where such data may be further processed to improve the correction factor.

In order to apply the facial feature measurements to interface sizing, whether corrected or uncorrected by the anthropometric correction factor, the measurements may be scaled from pixel units to other values that accurately reflect the distances between the user's facial features as presented for image capture. The reference feature may be used to obtain a scaling value or values. Thus, the processor 310 similarly determines the reference feature's dimensions, which can include pixel width and/or pixel height (x and y) measurements (e.g., pixel counts) of the entire reference feature. More detailed measurements of the pixel dimensions of the many squares/dots that comprise a QR code reference feature, and/or pixel area occupied by the reference feature and its constituent parts may also be determined. Thus, each square or dot of the QR code reference feature may be measured in pixel units to determine a scaling factor based on the pixel measurement of each dot and then averaged among all the squares or dots that are measured, which can increase accuracy of the scaling factor as compared to a single measurement of the full size of the QR code reference feature. However, it should be understood that whatever measurements are taken of the reference feature, the measurements may be utilized to scale a pixel measurement of the reference feature to a corresponding known dimension of the reference feature.

Once the measurements of the reference feature are taken by the processor 310, the scaling factor is calculated by the processor 310 as controlled by the application. The pixel measurements of reference feature are related to the known corresponding dimensions of the reference feature, e.g., the reference feature 326 as displayed by the display interface 320 for image capture, to obtain a conversion or scaling factor. Such a scaling factor may be in the form of length/pixel or area/pixelA2. In other words, the known dimension(s) may be divided by the corresponding pixel measurement(s) (e.g., count(s)).

The processor 310 then applies the scaling factor to the facial feature measurements (pixel counts) to convert the measurements from pixel units to other units to reflect distances between the user's actual facial features suitable for head mounted display interface sizing. This may typically involve multiplying the scaling factor by the pixel counts of the distance(s) for facial features pertinent for head mounted display interface sizing.

These measurement steps and calculation steps for both the facial features and reference feature are repeated for each captured image until each image in the set has facial feature measurements that are scaled and/or corrected.

The corrected and scaled measurements for the set of images may then optionally be averaged or weighted by some statistical measure such as uncertainty by the processor 310 to obtain final measurements of the user's facial anatomy. Such measurements may reflect distances between the user's facial features.

In the comparison and output phase, results from the post-capture image processing phase may be directly output (displayed) to a person of interest or compared to data record(s) to obtain an automatic recommendation for an existing head-mounted display interface.

Once all of the measurements are determined, the results (e.g., averages) may be displayed by the processor 310 to the user via the display interface 320. In one embodiment, this may end the automated process. The user can record the simpler measurements for further use.

Alternatively, the final measurements may be forwarded either automatically or at the command of the user to the server 210 from the computing device 230 via the communication network 220. The server 210 or individuals on the server-side may conduct further processing and analysis to determine a customized head-mounted display interface based on more complex measurement data.

In a further embodiment, the final facial feature measurements that reflect the distances between the actual facial features of the user are compared by the processor 310 to dimensional data of different head-mounted display interfaces such as in a data record. The data record may be part of the application for automatic facial feature measurements and head-mounted display interface sizing. This data record can include, for example, a lookup table accessible by the processor 310, which may include head-mounted display interface sizes corresponding to a range of facial feature distances/values. Multiple tables may be included in the data record, many of which may correspond to a particular form of head-mounted display interface and/or a particular model of head-mounted display interface offered by the manufacturer.

The example process for selection of a head-mounted display interface identifies key landmarks from the facial image captured by the above mentioned method. In this example, initial correlation to potential interfaces involves facial landmarks such as nose depth. These facial landmark measurements are collected by the application to assist in selecting the size of a compatible interface such as through the lookup table or tables described above. Other facial landmarks or features may be determined in order to customize the support a facial interfacing structure for a head-mounted display interface tailored for a specific user. As will be explained such landmarks may include forehead curvature, head width, cheek bone location, Rhinion profile and the nose width that may be appropriate to devices such as VR goggles or AR headwear. Other facial features may be identified and otherwise characterized for the purposes of designing the supporting interface of the head-mounted display interface to either minimize or avoid contact with facial regions that may cause discomfort.

Machine learning may be applied to provide additional correlations between facial interfacing structure types and characteristics to factors such as sustained use of the interface without user discomfort. The correlations may be employed to select or design characteristics for new head-mounted display interface designs. Such machine learning may be executed by the server 210. A facial interface analysis algorithm may be learned with a training data set based on the outputs of favorable operational results and inputs including user demographics, interface sizes and types, and subjective data collected from users. Machine learning may be used to discover correlation between desired interface characteristics and predictive inputs such as facial dimensions, user demographics, and operational data from the VR devices. Machine learning may employ techniques such as neural networks, clustering or traditional regression techniques. Test data may be used to test different types of machine learning algorithms and determine which one has the best accuracy in relation to predicting correlations. For example, it may be found that a ML model that maximizes comfort (at the interface, weight and strain on the neck), but minimizes light bleed is the optimal model.

The model for selection of an optimal facial interfacing structure may be continuously updated by new input data from the system in FIG. 4. Thus, the model may become more accurate with greater use by the analytics platform.

The present process allows for collection of feedback data and correlation with facial feature data to provide interface designers data for designing other facial interfacing structures or other headwear. As part of the application 360 that collects facial data or another application executed by a computing device such as the computing device 230 or the mobile device 234 in FIG. 4, feedback information relating to the interface may be collected.

In this example, the application 360 collects use of a series of images to generate a model of the user's head. The image data or data derived by the image data such as the model allows for measurements of key landmarks to customize a facial interfacing structure such as the facial interfacing structure 1100 in FIG. 2A. The customization may thus include the processor or controller executing the application 360 to determine dimensions of a facial interfacing structure based on the model derived from the facial feature data.

The key landmarks for the facial interfacing structure 1100 in this example are: forehead curvature, head width, cheek bone dimensions, the Rhinion profile (where the light seal engages the user), and nose width across the nostrils. The relation of locations of these landmarks may also be considered. Such facial features may be derived from the scanned facial images or the facial model derived from the images of the facial features of the user.

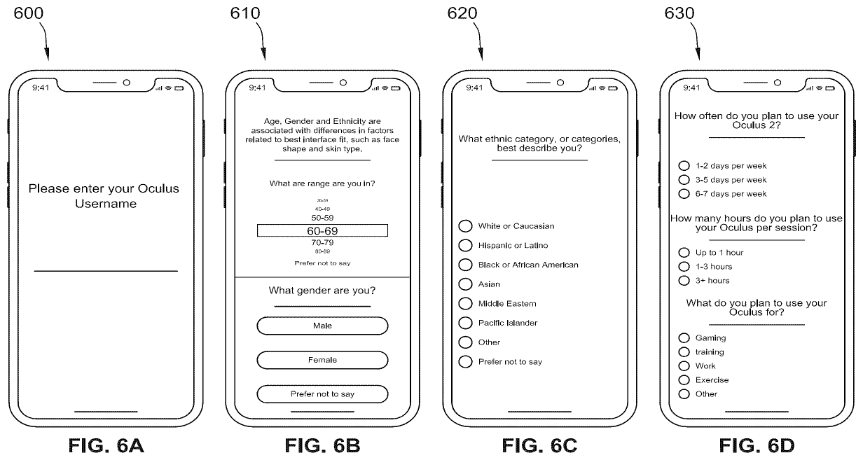

FIG. 6A is a screen image of an interface 600 generated by the application 360 for collection of user name data for an individualized head mounted display. The user name may be coordinated with a user name for a virtual reality service. FIG. 6B is a screen image of an interface 610 for collection of user demographic data for an individualized head mounted display. The interface 610 collects age and gender demographic data. This data may be incorporated to better optimize dimensions of the individualized head mounted display.

FIG. 6C is a screen image of an interface 620 for collection of the ethnicity of the user demographic data for an individualized head mounted display. FIG. 6D is a screen image of an interface 630 for collection of data for use of an individualized head mounted display. The user may provide information about the times per week and the amount of time of using the head mounted display. The interface 630 also collects information regarding the category of use of the head mounted display that may be relevant for the features of the head mounted display such as work versus entertainment. The categories in this example including gaming, training, work, and exercise.

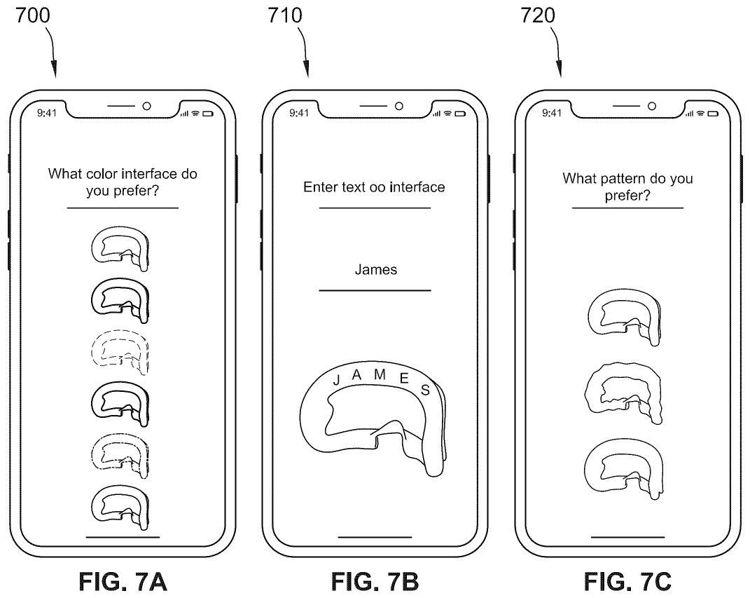

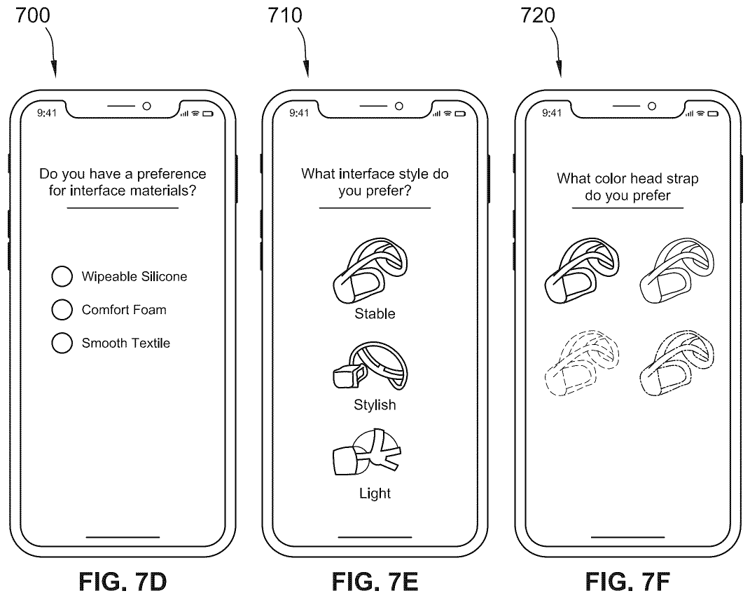

FIGS. 7A-7F are selection interfaces that allow a user to select different features that are not related to the facial dimensions for further individualization of their head mounted display. Thus, FIG. 7A is a screen image of an interface 700 to allow the selection of the color of an individualized head mounted display. The interface 700 displays available colors that may be provided for the interface and shows different graphics of the interface in the available colors. A user may select a graphic of the interface in the desired color to enter the color input. FIG. 7B is a screen image of an interface 720 to allow the application of an identifier of an individualized head mounted display. The interface 720 allows the entry of a name or other identifier to be labeled on the head mounted display. The user may enter a name and the entered name will be displayed on a graphic of the interface to show the user the appearance of the entered name on the head mounted display. FIG. 7C is a screen image of an interface 730 to allow the selection of the pattern of an individualized head mounted display. The interface 730 displays a selection of patterns that are different textures or shapes for user comfort, grip, or thermal management.

FIG. 7D is a screen image of an interface 740 to allow the selection of the material of an individualized head mounted display. In this example, the interface 740 allows the selection between wearable silicone, comfort foam, and smooth textile. FIG. 7E is a screen image of an interface 750 to allow the selection of the style of an individualized head mounted display. For example, the styles available may include a stable style, an aesthetics style, or a light style. The style may affect functional characteristics such as reducing movement of the head mounted display when a user moves their head or the weight when the head mounted display is worn for long periods of time. FIG. 7F is a screen image of an interface 760 to allow the selection of the color of the strap for an individualized head mounted display and shows different graphics of the strap in the available colors. A user may select a graphic of the strap in the desired color to enter the color input.

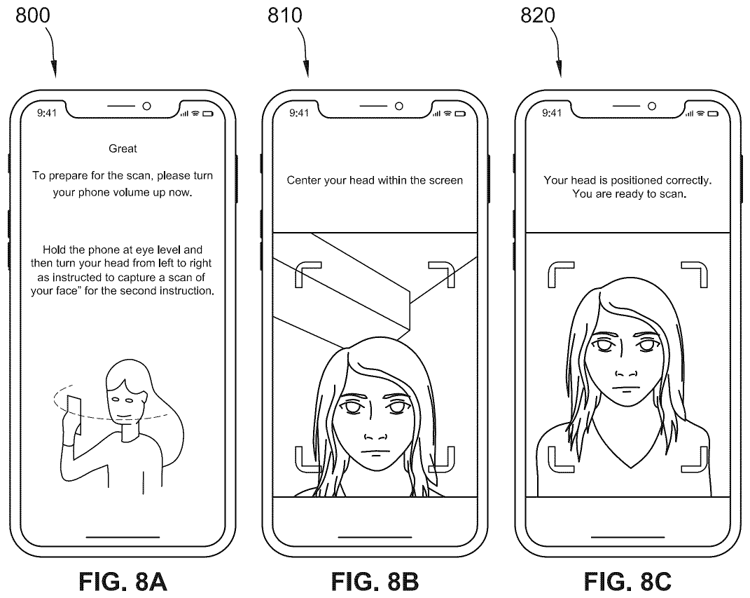

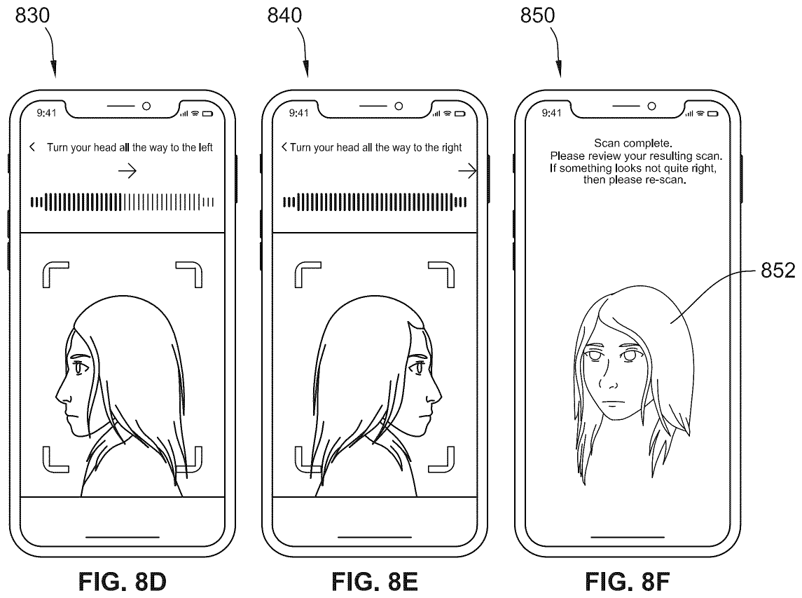

FIG. 8A is a screen image of an interface 800 that instructs a user to capture images of their face. The interface 800 is generated by the application 360 and provides information on the above process for capturing facial image data. FIG. 8B is a screen image of an interface 810 that instructs a user to align their face for the image capture and displays a targeting reticle. Once a user is ready, the application 360 will begin to capture facial images. In this example, the application 360 requires a frontal facial image and side facial images to collect the facial images required for the measurements of landmarks described above. The images may be different types of images such as depth images, RGB images, or point clouds.

FIG. 8C is a screen image of an interface 820 that is displayed to capture a front facial image. The front image serves as a starting point for additional images. The application 360 will instruct a user to turn their head. FIG. 8D is a screen image of an interface 830 that captures one set of side facial images after a user has taken the front facial image and turns to one side. FIG. 8E is a screen image of an interface 840 that captures another set of side facial image after the first set of side images is captured. The interface 840 is displayed when the user turns to the other side. FIG. 8F is a screen image of an interface 850 displaying a 3D head model determined from the captured facial images. The captured image data is stored and may be sent to an external device for further processing.

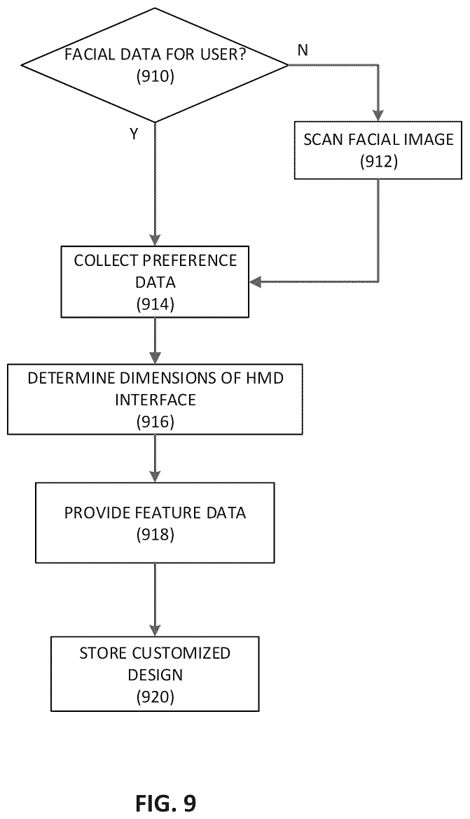

FIG. 9 is a facial data collection routine that may be run to allow the design of a specific interface for a user. The flow diagram in FIG. 9 is representative of example machine readable instructions for collecting and analyzing facial data to select characteristics of a customized facial interfacing structure of a head-mounted display interface for immersive experiences such as VR or AR. In this example, the machine readable instructions comprise an algorithm for execution by: (a) a processor; (b) a controller; and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit [ASIC], a programmable logic device [PLD], a field programmable logic device [FPLD], a field programmable gate array [FPGA], discrete logic, etc.). For example, any or all of the components of the interfaces can be implemented by software, hardware, and/or firmware. Also, some or all of the machine readable instructions represented by the flowcharts may be implemented manually. Further, although the example algorithms are described with reference to the flowchart illustrated in FIG. 9, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The routine first determines whether facial data has already been collected for the user (910). If facial data has not been collected, the routine activates the application 360 to request a scan of the face of the user using a mobile device running the above described application such as the mobile device 234 in FIG. 4 (912).

After the facial image data is collected (912) or if the facial data already is stored from a previous scan, the routine then accesses the facial image data that is stored in a storage device and correlates the data to the user. The routine then accesses collected preference data from the user (914). The preference data is collected from an interface of the user application 360 executed by the computing device 230. As explained above, the preferences data may be collected via interfaces that provide selections as to color, pattern, etc. to the user.

The routine then analyzes objective data such as facial feature data from the facial image data and subjective data for modifications of dimensions of a basic head-mounted display interface (916). Subjective data may include user feedback from wearing an existing interface. The routine then applies the data for the selected features such as color, pattern, material and the like (918). The routine then stores the design data for the customized head-mounted display interface in a storage device (920).

The routine in FIG. 9 may also provide a recommendation for design modifications on different characteristics of standard interfaces such as the areas in contact with the facial area. This data may also continuously update the example machine learning driven correlation engine. The data may also be collected to recommend the selection from a set of interfaces that may be best suited for the user if specific custom production is unavailable. The routine may also be modified to generate a display interface that shows a model of the head-mounted display interface on an image of the face of the user on the computing device 230. The image of the display interface may be made semi-transparent to allow a user to check whether the display interface is properly fit to their face. The image may also be modified to show user selections of the color, texturing, pattern, material, identification labels, as well as other accessories such as different straps.

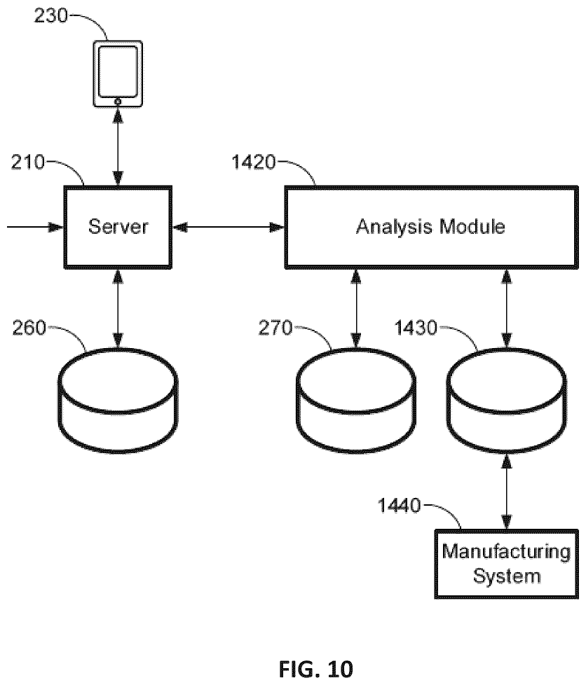

FIG. 10 is an example production system 1400 that produces customized interfaces based on the collected data from the data collection system 200 in FIG. 4. The server 210 provides preference data gathered by the application 360 from an individual user as well as a population of users to an analysis module 1420. The preference data is stored in a user database 260.

The analysis module 1420 includes access to an interface database 270 that includes data relating to different models of interfaces for one or more different manufacturers. The analysis module 1420 may include a machine learning routine to provide suggested changes to characteristics or features of a facial interfacing structure for a specific users or a facial interfacing structure used by one subgroup of the population of users. For example, the collected operation and user input data in conjunction with facial image data may be input to the analysis module 1420 to provide a new characteristic for the existing interface design or to use an existing interface design as a baseline to provide a completely customized interface. The manufacturing data such as CAD/CAM files for existing interface designs are stored in a database 1430. The modified design is produced by the analysis module and communicated to a manufacturing system 1440 to produce a facial interfacing structure with the modifications in dimensions, sizing, materials, etc. according to the individualized facial landmarks/features as well as user selected preferences such as color, pattern, style and the like. In this example, the manufacturing system 1440 may include tooling machines, molding machines, 3D printing systems, and the like to produce masks or other types of interfaces.

For a more efficient method of manufacturing custom components than additive manufacturing, the molding tools in the manufacturing system 1440 can be rapidly prototyped (e.g., 3D printed) based on the proposed modifications. In some examples, rapid three-dimensional printed tooling may provide a cost-effective method of manufacturing low volumes. Soft tools of aluminum and/or thermoplastics are also possible. Soft tools provide a low number of molded parts and are cost effective compared to steel tools.

Hard tooling may also be used during the manufacture of custom components. Hard tooling may be desirable in the event of favorable volumes of interfaces being produced based on the collected feedback data. Hard tools may be made of various grades of steel or other materials for use during molding/machining processes. The manufacturing process may also include the use of any combination of rapid prototypes, soft and hard tools to make any of the components of the head-mounted display interface. The construction of the tools may also differ within the tool itself, making use of any or all of the types of tooling for example: one half of the tool, which may define more generic features of the part may be made from hard tooling, while the half of the tool defining custom components may be constructed from rapid prototype or soft tooling. Combinations of hard or soft tooling are also possible.

Other manufacturing techniques may also include multi-shot injection molding for interfaces having different materials within the same component. For example, a cushion or pad may include different materials or softness grades of materials at different areas of the head-mounted display interface. Thermoforming (e.g., vacuum forming), which involves heating sheets of plastic and vacuuming the sheets onto the tool mold and then cooling the sheets until it takes the shape of the mold may also be used. In a yet another form, a material which may be initially malleable may be used to produce a customized user frame (or any other suitable component such as a headgear or portions thereof, such as a rigidizer). A ‘male’ mold of the user may be produced using one or more techniques described herewithin, upon which a malleable ‘template’ component may be placed to shape the component to suit the user. Then, the customized component may be ‘cured’ to set the component so that it would no longer be in a malleable state. One example of such a material may be a thermosetting polymer, which is initially malleable until it reaches a particular temperature (after which it is irreversibly cured), or a thermosoftening plastic (also referred to as thermoplastic), which becomes malleable above a particular temperature. Custom fabric weaving/knitting/forming may also be used. This technique is similar to three-dimensional printing processes except with yarn instead of plastic. The structure of the textile component may be knitted into any three-dimensional shapes, which are ideal for fabricating the custom facial interfacing structure.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

One or more elements or aspects or steps, or any portion(s) thereof, from one or more of any of claims 1-31 below can be combined with one or more elements or aspects or steps, or any portion(s) thereof, from one or more of any of the other claims 1-31 or combinations thereof, to form one or more additional implementations and/or claims of the present disclosure.

While the present disclosure has been described with reference to one or more particular embodiments or implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations or alternative implementations according to aspects of the present disclosure may combine any number of features from any of the implementations described herein, such as, for example, in the alternative implementations described below.

1. A method of collecting data for customizing a facial interfacing structure for a head-mounted display interface, the method comprising:
correlating facial image data to a user;
determining facial feature data from the facial image data;
determining dimensions of the facial interfacing structure to determine points of engagement of the face of the user with the facial interfacing structure from the facial feature data; and
storing a design of a customized facial interfacing structure including the determined dimensions.

2. The method of claim 1, wherein the head-mounted display interface is part of a virtual reality system, an augmented reality system, or a modified reality system.

3. The method of claim 1, wherein the facial image data is taken from a mobile device with an application to capture the facial image of the user.

4. The method of claim 1, further comprising displaying a feature selection interface on a display for user input, wherein the design includes the user input.

5. The method of claim 4, wherein the user input is one of a selection of a customized head-mounted display interface including the customized facial interfacing structure; a color, an identifier, a pattern, or a style of the facial interfacing structure; or a cushioning material for the facial interfacing structure.

6-7. (canceled)

8. The method of claim 1, wherein the determination of the dimensions of the feature selection interface includes evaluating demographic data, ethnicity, and use of headwear by the user.

9. The method of claim 1, wherein the facial feature data includes forehead curvature, head width, cheek bones, Rhinion profile, and nose width.

10. The method of claim 1, wherein determining facial feature data includes detecting one or more facial features of the user in the facial image data and a predetermined reference feature having a known dimension in the facial image data.

11. The method of claim 10, wherein determining facial feature data includes processing image pixel data from the facial image data to measure an aspect of the one or more facial features detected based on the predetermined reference feature.

12-13. (canceled)

14. The method of claim 1, wherein determining dimensions of the facial interfacing structure includes selecting a facial interface size from a group of predetermined facial interface sizes based on a comparison between the facial feature data and a data record relating sizing information of the group of standard facial interface sizes and the facial feature data.

15-16. (canceled)

17. The method of claim 1, wherein the dimensions of the facial interfacing structure are determined to minimize light leak of the facial interfacing structure when worn by the user or to minimize gaps between the face of the user and of the facial interfacing structure.

18. (canceled)

19. The method of claim 1, further comprising training a machine learning model to output a correlation between at least one facial feature and dimensions of the facial interfacing structure, wherein the determining dimensions of the facial interfacing structure includes the output of the trained machine learning model executed by a processor.

20. The method of claim 19, wherein the training includes providing the machine learning model a training data set based on the outputs of favorable operational results of facial interfacing structures, user facial feature inputs, and subjective data collected from users.

21-23. (canceled)

24. A method of manufacturing a customized facial interfacing structure for a head-mounted display interface, the method comprising:
correlating facial image data to a user;
determining facial feature data from the facial image data;
determining dimensions of the facial interfacing structure from the facial feature data via a processor;
storing a design of a customized facial interfacing structure including the determined dimensions in a storage device; and
fabricating the customized facial interface structure via a manufacturing system based on the stored design.

25. The method of claim 24, wherein the manufacturing system includes at least one of a tooling machine, a molding machine, or a 3D printer.

26. The method of claim 24, wherein the head-mounted display interface is part of a virtual reality system, an augmented reality system, or a modified reality system.

27. The method of claim 24, wherein the facial image data is taken from a mobile device with an application to capture the facial image of the user.

28. The method of claim 24, further comprising displaying a feature selection interface and collecting preference data from the user of a color, an identifier, a pattern, or a style of the customized facial interface structure, wherein the fabricating includes incorporating the preference data from the user.

29. The method of claim 24, further comprising displaying a feature selection interface and collecting preference data from the user of cushioning material for the customized facial interface structure, wherein the fabricating includes incorporating the cushioning material based on the collected preference data.

30. A manufacturing system for producing a customized facial interfacing structure for a head-mounted display interface, the system comprising:
a storage device storing facial image data of a user;
a controller coupled to the storage device, the controller operable to:
determine facial feature data of the user from the facial image data;
determine dimensions of the facial interfacing structure from the facial feature data; and
store a design of the customized facial interfacing structure including the determined dimensions in the storage device; and
a manufacturing device coupled to the controller that fabricates the customized facial interface based on the stored design.

31. (canceled)
